(19) United States
(12) Patent Application Publication
(10) Pub. No.: US 2019/0311629 A1
(43) Pub. Date: Oct. 10, 2019

(54) GENERATING AND MANAGING VIRTUAL QUEUES AT CONGESTED VENUES

(71) Applicant: Lyft, Inc., San Francisco, CA (US)

(72) Inventors: Lily Sierra, San Francisco, CA (US); Danial Afzal, San Francisco, CA (US); Elijah Pike Flesher, Seattle, WA (US); Jisi Guo, San Francisco, CA (US); Alexander James Hillis, Belmont, CA (US); Fahri Tasdelen, San Francisco, CA (US)

(21) Appl. No.: 15/947,708

(22) Filed: Apr. 6, 2018

(51) Int. Cl. G08G 1/00; G06Q 10/02; G07C 9/00; H04W 4/02

(52) U.S. Cl. CPC G08G 1/202; H04W 4/023; G07C 9/00103; G06Q 10/02

(57) ABSTRACT

The present application discloses an improved transportation matching system, and corresponding methods and computer-readable media. According to disclosed embodiments, a transportation matching system provides a virtual queue in connection with a congested venue. In response to receiving a transportation request from a requestor at a congested venue, the system adds the requestor to a virtual queue. The system then adjusts the virtual queue position as necessary based on the requestor's speed and direction of travel in relation to the venue's pickup location. When the requestor reaches the front of the virtual queue, the system provides a requestor identifier to the requestor. The requestor can then use the requestor identifier to engage any available provider at the venue's pickup location.

### BACKGROUND

The popularity and utilization of mobile app-based transportation matching systems has grown significantly in recent years. Through such a transportation matching system, a requestor utilizes a requestor computing device to generate and send a transportation request including a pickup location and a destination location. The system then matches the transportation request to a transportation provider computing device associated with a provider, after which the provider transports the requestor to the destination location.

While this conventional matching method works well for distributed requestors (e.g., requestors who are walking down the street, waiting outside a place of business, waiting at home), problems arise within specific requestor contexts. For example, problems arise in connection with specific venues (or other locations, regions, or zones with controlled pickup locations) where large numbers of requestors can only be picked up at a single or a small number of locations for the given number of requestors—for example, venues such as airports, sports arenas, train stations, or ad hoc festival grounds. In these contexts, conventional transportation matching systems fail to provide a requestor solution that addresses the multiple inefficiencies that arise from large numbers of requestors trying to request transportation in connection with a single, controlled pickup location.

For instance, conventional transportation matching systems fail to prevent long wait times that arise in venues such as airports, stadiums, and festivals. To illustrate, requestors generally experience longer than normal wait times at an airport because providers must move from a staging lot to the pickup location after a match is made between a requestor and a provider. Furthermore, once a requestor's matched provider arrives at the pickup location, the requestor typically wastes additional time trying to locate the matched provider in a congested pickup location where other requestors are also trying to find their matched providers. These longer requestor wait times lead to additional system inefficiencies as conventional transportation matching systems expend system resources in attempting to match additional requestors and providers while the system becomes further backlogged.

Accordingly, a need exists for a transportation matching system that provides a solution specific to venues that experience large numbers of requestors with few pickup locations.

### BRIEF DESCRIPTION OF THE DRAWINGS

The detailed description refers to the drawings briefly described below.

FIG. 1 illustrates an environmental diagram of a transportation matching system in accordance with one or more embodiments;

FIG. 2 illustrates an overview of an example venue in accordance with one or more embodiments;

FIG. 3 illustrates a sequence diagram of a series of acts performed by the transportation matching system in providing a virtual queue in accordance with one or more embodiments;

FIGS. 4A-4F illustrate a series of graphical user interfaces displayed by an example requestor computing device in accordance with one or more embodiments;

FIGS. 5A-5B illustrate a series of graphical user interfaces displayed by an example requestor computing device in accordance with one or more embodiments;

FIGS. 6A-6D illustrate a series of graphical user interfaces displayed by an example kiosk computing device in accordance with one or more embodiments;

FIG. 7 illustrates a schematic diagram of the transportation matching system in accordance with one or more embodiments;

FIG. 8 illustrates a flowchart of a series of acts in a method of providing a virtual queue in accordance with one or more embodiments;

FIG. 9 illustrates a block diagram of an exemplary computing device in accordance with one or more embodiments; and

FIG. 10 illustrates an example network environment of a transportation matching system in accordance with one or more embodiments.

### DETAILED DESCRIPTION

This application discloses various embodiments of a transportation matching system, computer readable media, and corresponding methods that provide benefits and/or solve the foregoing problems in the art. In accordance with one or more embodiments, a transportation matching system provides a virtual queue that enables requestors to utilize any available provider at a pickup location of a congested venue instead of limiting the requestor to a particular matched provider. Specifically, the transportation matching system balances the number of requestors who can utilize any available provider with the number of providers who are available at the pickup location by utilizing a virtual queue and distributing requestor identifiers to requestors who are ready to leave with an available provider (e.g., driver).

For example, the transportation matching system provides a virtual queue by adding a requestor to a virtual queue in response to receiving a transportation request from that requestor at a specific venue, such as an airport or stadium. Once the requestor moves to the top of the virtual queue, and based on the requestor's location and provider availability, the transportation matching system assigns a requestor identifier (e.g., a personal identification number (“PIN”), passcode, or other semi-unique information) to the requestor. In at least one embodiment, the requestor can provide the requestor identifier to any available provider at the pickup location, and the transportation matching system automatically matches the requestor's transportation request to that provider including providing a destination location, requestor information, and/or any other relevant information to the provider for completing the request. In this way, the transportation matching system overcomes previous problems specific to particular venues by eliminating excess requestor wait times, physical queues, congested pickup locations, and provider time waste.

For example, most airport typically feature long physical queues where people must wait before engaging with available transport. Thus, even if a person quickly makes their way from their arrival terminal in order to leave the airport quickly, the person has no way to anticipate how long they will have to stand in the physical queue. This type of physical queue frequently results in anger and frustration for the people who must wait in it.

Additionally, a user waiting in a typical queue has no way to specify preferences associated with their desired transport (e.g., vehicle size, vehicle type, driver rating). Accordingly, the present transportation matching system solves these and other problems by utilizing a virtual queue that enables a user to engage with a transportation provider without having to waiting in a frustrating physical queue. Similarly, because the virtual queue carefully manages the number of requestors who can engage with waiting providers at one or more pickup locations associated with a particular venue, the transportation matching system eliminates crowded and confusing pickup locations that are common in connection with typical physical queues. No physical lines are required and instead, requestors may enter any available vehicle upon receipt of a PIN or other unique identifier allowing them to initiate a ride. This further speeds up the pickup experience as requestors are not rigidly required to find a particular vehicle that may be further away from them and/or difficult to see or find compared to other available vehicles. Instead, the provider may enter the first available vehicle they happen to find and may provide their unique identifier to “match” or tie the requestor and provider information to one another and initiate a ride.

To further illustrate the features and functionality of the transportation matching system, the matching process begins when the transportation matching system receives a transportation request from a transportation matching system application on a requestor computing device located at a particular venue. In response to receiving the transportation request, the transportation matching system adds the requestor computing device associated with the transportation request to a virtual queue. In one or more embodiments, the virtual queue is specific to the current venue and/or specific to one of multiple pickup locations associated with the current venue where the requestor computing device is located. As such, the virtual queue contains all the requestor computing devices at the current venue that have submitted transportation requests but have not been assigned requestor identifiers.

In one or more embodiments, a requestor computing device's position in the virtual queue is not static. Instead, the transportation matching system can reassign the request computing device to a new position or otherwise adjust the position in the virtual queue based on various signals associated with the requestor, providers, venue, amount of congestion, pickup location, and/or any other relevant information. For example, in response to analyzing location data associated with the requestor computing device, the transportation matching system can anticipate how long it will take the requestor computing device to arrive at the venue's specified pickup location (e.g., how long it will take the requestor to walk from an arrival gate to the pickup curb at an airport). In response to determining that the requestor computing device will arrive at the pickup location before other requestor computing devices with higher positions in the virtual queue (e.g., because the requestor walks faster, because other requestors stop at a restroom or gift shop), the transportation matching system can move the requestor computing device to a more favorable virtual queue position.

In at least one embodiment, the transportation matching system continually determines when to provide requestor identifiers to requestor computing devices in the virtual queue. For example, the transportation matching system can determine when to provide a requestor identifier to a requestor computing device based on the requestor computing device's current virtual queue position, in combination with a number of requestor computing devices that have already been provided requestor identifiers and a number of currently available provider computing devices. In one or more embodiments, the transportation matching system seeks to provide a requestor identifier to a requestor computing device only once the requestor computing device is transport ready (e.g., at or near the pickup location), and there is a provider computing device that is currently available to meet the requestor computing device at the pickup location.

In response to providing a requestor identifier to a requestor computing device, the requestor associated with the requestor computing device can utilize any available provider at the pickup location. For example, the requestor can get into any available transport at an airport pickup curb. At that point, the requestor can provide the requestor identifier to the provider, who in-turn provides the requestor identifier to the transportation matching system. In response to receiving the requestor identifier from the provider computing device, the transportation matching system automatically matches the transportation request associated with the requestor to the provider computing device. After making the match, the transportation matching system provides requestor identifying information and route information to the provider computing device.

As such, the transportation matching system provides a computer-based solution to existing problems in providing transportation at congested venues. For example, the present transportation matching system eliminates previous system resource waste by reducing wait time for transportation requestors and transportation providers. By reducing wait time, the transportation matching system boosts system efficiency and throughput by providing transportation to more users at congested venues than conventional transportation matching systems.

As used herein, a “requestor” refers to a transportation matching system user who is requesting transportation by way of a requestor computing device. For example, the requestor computing device can be a personal computing device (e.g., a mobile computing device such as a smartphone, a smart wearable, a tablet) installed with a transportation matching system application.

As used herein, a “transportation request” refers to a request for transportation received by the transportation matching system from a transportation matching system application installed on a requestor computing device. In one or more embodiments, a transportation request includes a pickup location, and a destination location specified by the requestor. In at least one embodiment, the transportation request can also include location data associated with the requestor computing device. For example, location data can include a current location of the requestor computing device, a current speed of movement averaged over a previous threshold amount of time (e.g., over the last 30 seconds) associated with the requestor computing device, and a direction of movement associated with the requestor computing device. The transporation request may include any suitable information to determine the pickup, dropoff, and/or current location of the requestor and/or that may be used by the transportation matching system to match a transportation request and/or provide transportation to the requestor.

As used herein, a “provider” refers to a transportation matching system user who provides transportation using a vehicle. For example, a provider receives transportation requests, routing information, and requestor information from the transportation matching system via a transportation matching system application installed on a provider computing device associated with the provider. As with a requestor computing device, the provider computing device can be a personal computing device such as smart phone. In some embodiments, providers may include non-human driven autonomous vehicles that are configured to perform transportation completely without or with very little direction or interaction from a human driver. In such cases, the provider computing device may include a computing system of the autonomous vehicle that is configured to interface with the transportation matching system.

As used herein, a “congested venue” refers to a particular location, region, or zones associated with a limited number of pickup locations that regularly or periodically experiences high numbers of transportation matching system requestors. As non-limiting examples, congested venues can include airports, sports arenas, concert halls, festival locations, and mass transit centers. Furthermore, a congested venue can refer to any location, region, or zone where the number of requestors to pickup locations during a particular time period is consistently disproportionate and/or where the pickup location is difficult to maneuver by providers and/or requestors. For example, the transportation matching system may determine that a particular restaurant is a congested venue from 6 pm-9 pm on Fridays (even though the restaurant is not associated with any event) because there are consistently four requestors waiting at the two pickup locations associated with the restaurant during that time and the pickup locations are difficult to maneuver by providers, causing delay in pickups and/or entering/exit of the pickup location. The transportation matching system can determine that a location is a congested venue based on historical requestor information associated with the location. Additionally or alternatively, the transportation matching system can determine that a location is a congested venue based on analysis of a web search, an event calendar, or current requestor activity that indicates the particular location is hosting a heavily attended event.

In one or more embodiments, a congested venue is associated with a limited number of controlled pickup locations. As used herein, a “pickup location” refers to a location associated with the congested venue where a requestor can engage a provider for transportation servers (e.g., where the provider can park or idle their car in order to a requestor to get into the car). In one or more embodiments, a pickup location includes one or more pickup positions. As used herein, a pickup location's number of “pickup positions” refers to the vehicular capacity of the pickup location. For example, a pickup location may only include two pickup positions. Thus, this pickup location has room for only two vehicles at a time.

In one or more embodiments, a congested venue is associated with a staging lot. As used herein, a “staging lot” is a location where providers can idle while waiting to receive a instructions to move to the pickup location associated with the congested venue. For example, an airport can include a waiting lot where a provider waits in their vehicle until the transportation matching system instructs the provider to move to the pickup location (e.g., a section of curb designated for providers to pick up requestors at the airport).

As used herein, a “virtual queue” (or “queue”) refers to a digital queue maintained by the transportation matching system in association with a congested venue. For example, in one or more embodiments, the transportation matching system initializes a virtual queue for a particular location in response to determining that the particular location is a congested venue. In one embodiment, the transportation matching system adds requestor computing devices to the virtual queue in a first-in first-out (FIFO) manner. In other embodiments, the transportation matching system adds requestor computing device to the virtual queue in other ways such as, but not limited to, a last-in-first-out (LIFO) manner, based on physical proximity to a pickup location, based on an estimated time of arrival at a pickup location, or any other suitable manner. In at least one embodiment, the transportation matching system reassigns the virtual queue position (or “queue position”) of a requestor computing device based on various determinations, as will be described in greater detail below.

Once a requestor computing device moves to a particular position within the virtual queue (e.g., the front of the virtual queue), the transportation matching system provides a requestor identifier (e.g., a requestor PIN) to the requestor computing device. For example, the transportation matching system may determine that the requestor computing device is in a position within the virtual queue that warrants providing a requestor identifier based on a number of available provider computing devices that are ready to be instructed to move to the pickup location at the venue. As used herein, a “requestor identifier” refers to a unique number (e.g., a four-digit number) provided by the transportation matching system to a requestor computing device. In one or more embodiments, and as will be described in greater detail below, a requestor identifier enables a requestor computing device to engage any available provider at the pickup location of a congested venue. In some embodiments, if a requestor does not utilize a provided requestor identifier within a threshold amount of time, the transportation matching system can expire the provided requestor identifier and enter the requestor back into the virtual queue and/or may remove them from the queue.

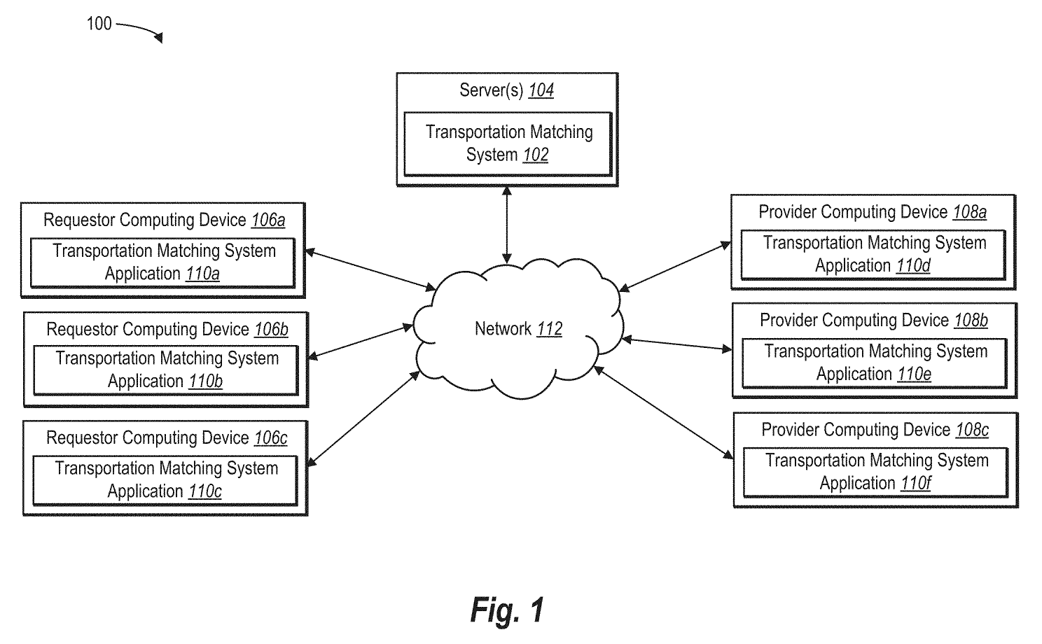

FIG. 1 illustrates an example environment 100 for the transportation matching system 102 including the requestor computing devices 106a, 106b, and 106c, the provider computing devices 108a, 108b, and 108c. As shown, in one or more embodiments, the transportation matching system 102 can be implemented on one or more server(s) 104. As further shown in FIG. 1, the requestor computing devices 106a-106c and the provider computing devices 108a-108c communicate with the transportation matching system 102 via a network 112.

In one or more embodiments, the network 112 may include one or more networks and may use one or more communication platforms or technologies suitable for transmitting data and/or communication signals. In one or more embodiments, the network 112 includes a cellular network. Alternatively, the network 112 can include the Internet or World Wide Web. Additionally or alternatively, the network 112 can include various other types of networks that use various communication technologies and protocols, such as a corporate intranet, a virtual private network (“VPN”), a local area network (“LAN”), a wireless local network (“WLAN”), a wide area network (“WAN”), a metropolitan area network (“MAN”), or a combination of two or more such networks.

As further illustrated in FIG. 1, each of the requestor computing devices 106a-106c and the provider computing devices 108a-108c include the transportation matching system application 110a, 110b, 110c, 110d, 110e, and 110f. In one or more embodiments, the transportation matching system application 110a-110f enable the users of the requestor computing devices 106a-106c and the users of the provider computing devices 108a-108c to interact with features of the transportation matching system 102. For example, requestors can configure and send transportation requests, and can receive requestor identifiers and match notifications via the transportation matching system applications 110a-110c. Providers can receive movement instructions and match notifications via the transportation matching system applications 110d-110f. In at least one embodiment, the transportation matching system applications 110a-110c include features specific to requestors, while the transportation matching system applications 110d-110f include features specific to providers.

In at least one embodiment, one or more requestor computing devices 106a-106c send a transportation request to the transportation matching system 102. As discussed above, a “transportation request” refers to information provided by the transportation matching system applications 110a-110c and utilized by the transportation matching system 102 to match transportation requests to the provider computing devices 108a-108c. In typical contexts, the transportation matching system 102 receives a transportation request from the transportation matching system application 110a (e.g., a mobile application for requestors) installed on the requestor computing device 106a and utilizes the information provided in the transportation request to match the request to the provider computing device 108a. For example, under typical contexts, the transportation matching system 102 matches the transportation request to the provider computing device 108a based on: proximity of the provider computing device 108a to a specified pickup location, provider ratings and preferences, and the specified destination location.

As mentioned above, however, the transportation matching system 102 assigns the requestor computing device 106a a position in the virtual queue in response to receiving a transportation request from the requestor computing device 106a in connection with a congested venue. For example, in response to receiving a transportation request from the requestor computing device 106a while the requestor computing device 106a is located at an airport, the transportation matching system 102 can add the requestor computing device 106a to the virtual queue. The transportation matching system 102 can then reposition the requestor computing device 106a in the virtual queue based on additional location data provided by the requestor computing device 106a.

When the requestor computing device 106a moves to the front of the virtual queue, the transportation matching system 102 provides a requestor identifier to the requestor computing device 106a and instructs a provider to move to the pickup location. As used herein, “movement instructions” or “match instructions” refers to instructions the transportation matching system 102 provides to a provider computing device that tell the provider associated with the provider computing device to move to a particular location in order to pick up a requestor. In one or more embodiments, movement instructions do not identify the requestor but instead informs the provider that a requestor is transport ready at the pickup location.

In one or more embodiments, the requestor (e.g., the user associated with the requestor computing device 106a) approaches the pickup location at the current venue, and provides the requestor identifier to the provider computing device 108a instructed to move to the pickup location. In response to receiving the requestor identifier from the provider computing device 108a, the transportation matching system 102 automatically matches the transportation request received from the requestor computing device 106a to the provider computing device 108a. At that point, the transportation matching system 102 provides requestor identifying information and transportation request route information to the provider computing device 108a, and the provider can fulfill the transportation request in the same manner as in a non-congested context.

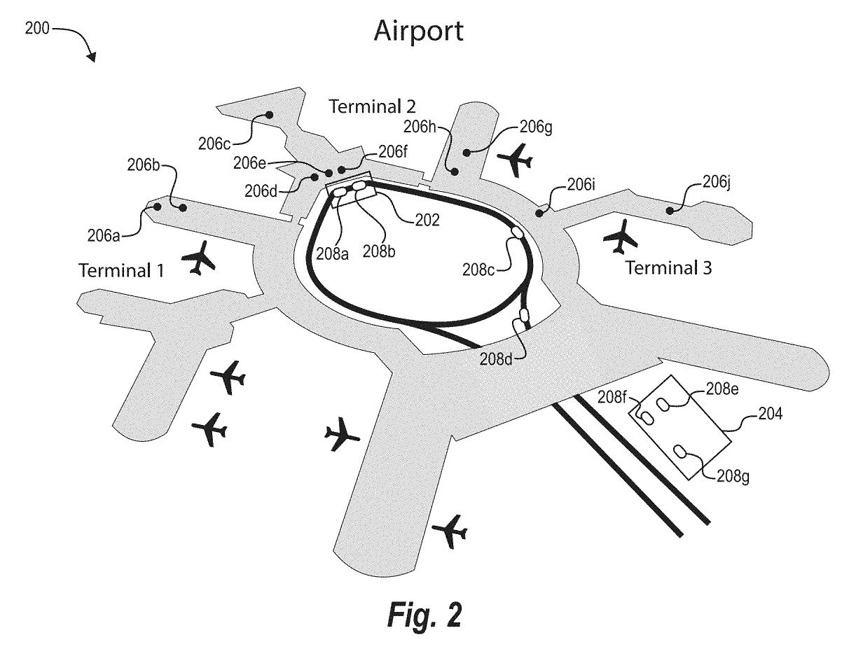

FIG. 2 illustrates an example overview of the features and functionality of the transportation matching system 102 in connection with a particular congested venue 200. For example, as shown in FIG. 2, the congested venue 200 is an airport. In one or more embodiments, the congested venue 200 includes a pickup location 202 with two pickup positions (e.g., capacity for two vehicles) and a staging lot 204. As mentioned above, even though the congested venue 200 is large, the congested venue 200 only includes a single pickup location 202—perhaps due to various constraints (e.g., contractual constraints, statutory constraints). Accordingly, requestors at the congested venue 200 may only engage with providers within the pickup location 202. In one or more embodiments, the pickup location 202 is geofenced such that the transportation matching system 102 can determine when and whether requestor computing devices and provider computing devices are within the pickup location 202.

Further illustrated in FIG. 2, the congested venue 200 includes a staging lot 204. In one or more embodiments, the congested venue 200 does not allow providers to idle or park at any point within the congested venue 200 except for the staging lot 204. Accordingly, in at least one embodiment, a provider waits in the staging lot 204 until the transportation matching system 102 provides an anonymous match to move to the pickup location 202. At that point, the provider moves from the staging lot 204 to the pickup location 202. The match is anonymous because a designated requestor and provider have not be identified by the match and instead, the anonymous match merely indicates that some requestor is ready for a pick up or will be ready for a pick up at the pickup location.

As an illustrative example, as shown in FIG. 2, the congested venue 200 includes requestor computing devices 206a-206j and provider computing devices 208a-208g. The requestor computing devices 206a-206j are at various locations within the congested venue 200, but only the requestor computing devices 206d, 206e, and 206f are near the pickup location 202 (e.g., “transport ready”). Furthermore, the provider computing devices 208a and 208b are inside the pickup location 202, with the provider computing devices 208c and 208d instructed to move and en route to the pickup location 202, and the provider computing devices 208e, 208f, and 208g idling or parked at the staging lot 204.

At some previous point in time, the provider computing devices 208a-208g traveled to the congested venue 200 and waited in the staging lot 204. For example, the providers associated with the provider computing devices 208a-208g may have decided to wait in the staging lot 204 of their own volition. Alternatively, the transportation matching system 102 may have instructed the provider computing devices 208a-208g to position themselves at the congested venue 200 in anticipation of an influx of transportation requests.

Similarly, at some previous point in time, the requestor computing devices 206d, 206e, and 206f sent transportation requests to the transportation matching system 102, and are now in possession of requestor identifiers (e.g., the requestor computing devices 206d-206f are not in the virtual queue at this point because the transportation matching system 102 has provided each with a requestor identifier). As such, the requestors associated with the requestor computing devices 206d-206f can engage with any of the provider computing devices 208a, 208b in the pickup location 202 (e.g., by getting into a vehicle associated with any of the provider computing devices 208a, 208b). Because the pickup location 202 includes only two pickup positions (e.g., indicated by the two provider computing devices 208a, 208b that fit into the pickup location 202), the transportation matching system 102 has previously provided movement instructions to the provider computing device 208c, such that the provider computing device 208c can move into the pickup location 202 as one of the provider computing devices 208a, 208b leaves the pickup location 202.

As shown in FIG. 2, the congested venue 200 includes the requestor computing devices 206a-206c, and 206g-206j at various distances from the pickup location 202. In one or more embodiments, the requestor computing devices 206g, 206h, 206i, and 206j have sent transportation requests to the transportation matching system 102, and the transportation matching system 102 has added the requestor computing devices 206g, 206h, 206i, 206j to the virtual queue. The transportation matching system 102 has not, however, provided each of the requestor computing devices 206g, 206h, 206i, and 206j with a corresponding requestor identifier. Furthermore, the requestor computing devices 206a and 206b have not sent transportation requests to the transportation matching system 102. As such, the transportation matching system 102 has neither added the requestor computing devices 206a and 206b to the virtual queue, nor has the transportation matching system 102 provided the requestor computing devices 206a and 206b with requestor identifiers.

In one or more embodiments, the requestor computing device 206c sends a transportation request to the transportation matching system 102. For example, the transportation request can include a destination location, as well as a request time (e.g., a timestamp associated with submission of the transportation request), and location data associated with the requestor computing device 206c. For instance, the location data can include a current location of the requestor computing device 206c, a current speed of movement averaged over a previous threshold amount of time (e.g., over the last 30 seconds) associated with the requestor computing device 206c, and a direction of movement associated with the requestor computing device 206c.

Upon receiving the transportation request, the transportation matching system 102 adds the requestor computing device 206c to the virtual queue including the requestor computing devices 206g-206j. In one or more embodiments, the transportation matching system 102 initially adds each new requestor computing device to the virtual queue in a first-in, first-out (FIFO) manner. Accordingly, upon receiving the transportation request from the requestor computing device 206c, the transportation matching system 102 can add the requestor computing device 206c to the back of the virtual queue.

In at least one embodiment, the transportation matching system 102 reassigns the virtual queue position of the requestor computing device 206c in response to an analysis of various information associated with the requestor computing device 206c. For example, in response to analyzing the location data associated with the requestor computing device 206c to determine that the current speed of movement associated with the requestor computing device 206c is greater than that of the requestor computing device 206i, the transportation matching system 102 may reassign the virtual queue position of the requestor computing device 206i to the requestor computing device 206c. The transportation matching system 102 may make this reassignment even though the requestor computing device 206i sent a transportation request to the transportation matching system 102 prior to the requestor computing device 206c sending a transportation request to the transportation matching system 102.

Furthermore, in response to determining that the requestor computing device 206h has stopped (e.g., stopped at a restroom or shop), while the requestor computing device 206c has remained steady in its current speed of movement, the transportation matching system 102 may again reassign the virtual queue position of the requestor computing device 206c such that the requestor computing device 206c is ahead of the requestor computing device 206h in the virtual queue. In one or more embodiments, the transportation matching system 102 may make this reassignment even though the requestor computing device 206h is physically closer to the pickup location 202 and the requestor computing device 206c is physically farther away from the pickup location 202.

At this point, regardless of each device's position in the virtual queue, the transportation matching system 102 has not provided a requestor identifier to any of the requestor computing devices 206c, and 206g-206j in the virtual queue. In one or more embodiments, the transportation matching system 102 provides a requestor identifier to the requestor computing device 206c based on the virtual queue position of the requestor computing device 206c, the number of requestor computing devices that already have requestor identifiers, and the number of available provider computing devices. As such, the transportation matching system 102 may provide a requestor identifier to the requestor computing device 206c when the requestor computing device 206c is at the top of the virtual queue (e.g., indicating that the requestor computing device 206c is physically near the pickup location 202), and after the requestor computing devices 206d-206f have engaged with the provider computing devices 208a-208c. At that point, the transportation matching system 102 instructs the provider computing device 208d to move to the pickup location 202, and provides a requestor identifier to the requestor computing device 206c.

In one or more embodiments, the requestor computing device 206c arrives at the pickup location 202 at roughly the same time as the provider computing device 208d. At that point, the requestor associated with the requestor computing device 206c can provide the requestor identifier to the provider associated with the provider computing device 208d (e.g., by verbally providing the requestor identifier). After the provider inputs the requestor identifier into the provider computing device 208d, the transportation matching system 102 automatically matches the transportation request from the requestor computing device 206c to the provider computing device 208d. In response to the match, the transportation matching system 102 provides additional information to the provider computing device 208d regarding the transportation request (e.g., a destination location, route information, requestor identification information). Similarly, the transportation matching system 102 can provide additional information to the requestor computing device 206c regarding the provider (e.g., provider identification information).

In at least one embodiment, the transportation matching system 102 can re-route provider computing devices already en route at venues with more than one pickup location based on a number of requestor computing devices that are transport ready. For example, the transportation matching system 102 may experience an influx of transportation requests at a crowded venue (e.g., in response to a flight landing). In at least one embodiment, the transportation matching system 102 may generate and maintain a virtual queue for each pickup location at the venue. As the transportation matching system 102 positions requestors in each virtual queue, the transportation matching system 102 can dynamically route and re-route provider computing devices from the staging lot 204 to each pickup location in order to meet the expected number of requestors at each pickup location.

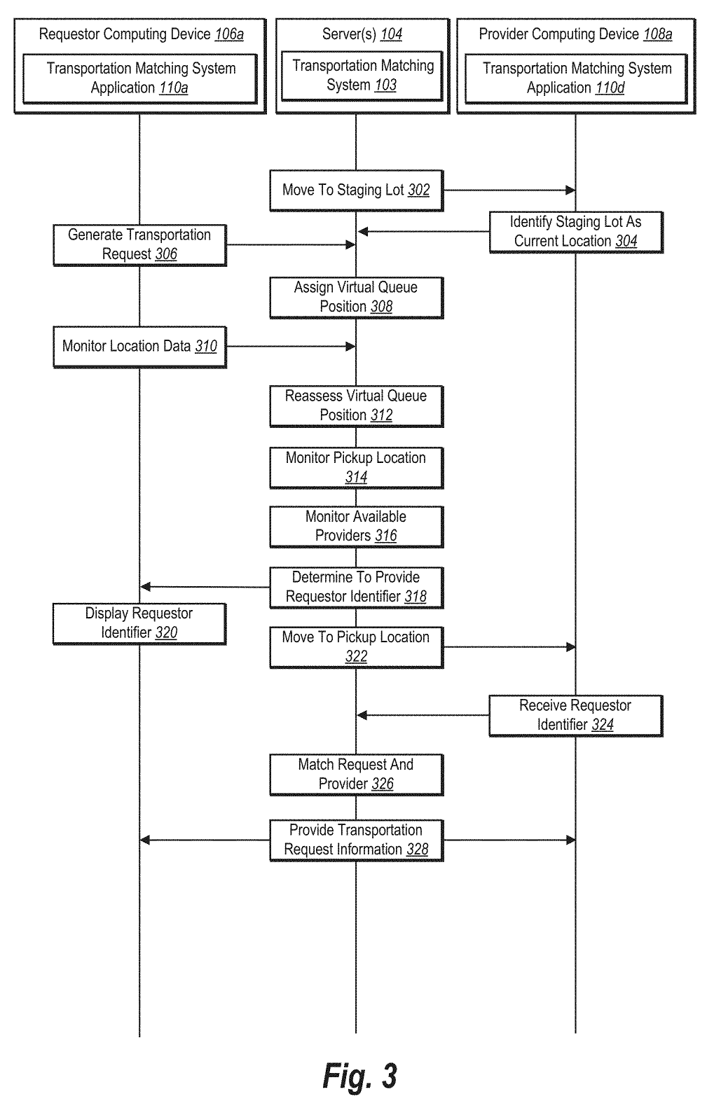

FIG. 3 illustrates a sequence diagram of a series of steps undertaken by the transportation matching system 102 in providing at least one virtual queue at congested venues. As shown in FIG. 3, the series of steps starts with the transportation matching system 102 instructing provider computing devices to move to a staging lot (302) associated with a particular venue. For example, in order to instruct provider computing devices to move to the staging lot (302) associated with a particular venue, the transportation matching system 102 can provide movement information to every provider computing device within a threshold distance from the venue (e.g., within 100 yards from the venue, within five minutes' drive time from the venue). The movement instructions can include information informing each nearby provider computing device that at least one requestor computing device is waiting at the venue, and that the provider computing device must travel to the venue's staging lot to wait for further movement information. In at least one embodiment, the movement information does not include any specific requestor identification information, nor does it include instructions to travel to the pickup location associated with the venue.

In one or more embodiments, the transportation matching system 102 can estimate provider computing device demand associated with the venue based on historical transportation request information. For example, it is possible that the venue experiences a fairly consistent volume of transportation requests (e.g., as with an airport). It is also possible that a venue experiences a more sporadic volume of transportation requests (e.g., as with a sports arena that does not host events every day of the week). Accordingly, the transportation matching system 102 can utilize historical transportation request information to forecast a likely volume of transportation requests for a given venue at a given time. Additionally, in at least one embodiment, the transportation matching system 102 also utilizes additional information (e.g., web searches, event calendars, flight status updates) in forecasting transportation request volume for a given venue during a period of time.

In response to receiving movement instructions from the transportation matching system 102, the provider associated with the provider computing device 108a travels to the staging lot associated with the venue. Upon arriving at the staging lot, the provider computing device 108a identifies the staging lot as the current location (304) of the provider computing device 108a and sends that current location to the transportation matching system 102. In one or more embodiments, the transportation matching system 102 will wait to further instruct the provider computing device 108a to move to the pickup location associated with the venue until a requestor computing device is transport ready and approaching the pickup location, as will be discussed further below.

In accordance with the transportation request volume forecasted by the transportation matching system 102, the requestor computing device 106a generates a transportation request (306). For example, the requestor computing device 106a generates the transportation request (306) in response to receiving user input that specifies a destination location. In one or more embodiments, the generated transportation request includes a current location and time associated with the requestor computing device 106a, the specified destination location, and an identifier associated with the requestor computing device 106a (e.g., an account number, a user ID). In at least one embodiment, the transportation request also includes location data associated with the requestor computing device 106a (e.g., an average speed of movement, a direction of travel).

In response to receiving a transportation request from the requestor computing device 106a and determining the requestor computing device 106a is currently located at the particular venue, the transportation matching system 102 assigns a virtual queue position (308) to the requestor computing device 106a. In one or more embodiments, because the transportation request from the requestor computing device 106a is the most recent transportation request associated with the venue, the transportation matching system 102 initially assigns the last virtual queue position to the requestor computing device 106a.

In alternative embodiments, the transportation matching system 102 can assign a virtual queue position to the requestor computing device 106a based on the time associated with the transportation request and the current location of the requestor computing device 106a. For example, if the requestor computing device 106a is located closer to the pickup location when submitting the transportation request, the transportation matching system 102 can position the requestor computing device 106a in the virtual queue ahead of other requestor computing devices that submitted earlier transportation requests but are located farther from the pickup location.

In addition to the time associated with the transportation request, the transportation matching system 102 can assign a virtual queue position to the requestor computing device 106a based on an estimated time of arrival for the requestor computing device 106a at the pickup location associated with the venue. For example, the transportation matching system 102 can analyze location data associated with the requestor computing device 106a (e.g., travel speed associated with the requestor computing device 106a, a direction of travel associated with the requestor computing device 106a, and a distance between the current location of the requestor computing device 106a and the pickup location) to determine a number of seconds or minutes in which the requestor computing device 106a will arrive at the pickup location. For example, the transportation matching system 102 may assign a better virtual queue position (e.g., closer to the front of the virtual queue, ahead of other requestor computing devices) to a requestor computing device with a faster travel speed, even though that requestor computing device submitted a transportation request after others already in the virtual queue, because the requestor computing device has an estimated time of arrival that will occur before that of the others in the virtual queue.

Additionally, the transportation matching system 102 can account for additional factors in assigning a virtual queue position to the requestor computing device 106a. In one or more embodiments, the transportation matching system 102 operates under a heuristic that emphasizes minimizing requestor crowding and wait time at the pickup location associated with the venue. Accordingly, in assigning virtual queue positions, the transportation matching system 102 accounts for a number of pickup locations at the venue (e.g., designated curb space where providers can pick up requestors), requestor computing devices with similar estimated times of arrival at the pickup location, requestor computing devices that are already located at the pickup location, a number of waiting or en route provider computing devices, and so forth. For example, the transportation matching system 102 may assign the requestor computing device 106a a virtual queue position toward the back of the virtual queue because of a number of requestor currently located at the pickup location, even though the requestor computing device 106a has an advantageous estimated time of arrival.

Furthermore, in additional or alternative embodiments, the transportation matching system 102 can assign a virtual queue position to the requestor computing device 106a based, at least in part, on an activity history associated with the requestor computing device 106a. For example, if an activity history associated with the requestor computing device 106a indicates that the transportation matching system 102 has previously provided requestor identifiers to the requestor computing device 106a at the same venue within 120 seconds of receiving a transportation request from the requestor computing device 106a, the transportation matching system 102 can assign a virtual queue position to the requestor computing device 106a that is likely to move to the front of the virtual queue within 120 seconds.

Additionally, the transportation matching system 102 can analyze activity histories of other requestor computing devices associated with the venue. For example, the transportation matching system 102 can analyze a history of transportation requests, ETAs (e.g., estimated times of arrival associated with other requestor computing devices), wait times, and so forth to determine that requestors at the venue typically move quickly to the pickup location. Conversely, the transportation matching system 102 may determine that requestors generally have longer ETA at the venue (e.g., as with venues that include shopping and restaurants). In one or more embodiments, the transportation matching system 102 utilizes this historical activity analysis to determine a historical average ETA. In at least one embodiment, the transportation matching system 102 can utilize this historical average ETA in assigning a virtual queue position for the requestor computing device 106a.

In one or more embodiments, the transportation matching system application 110a installed on the requestor computing device 106a continually monitors location data (310) associated with the requestor computing device 106a. For example, the transportation matching system application 110a monitors and updates the transportation matching system 102 with regard to an average speed of movement associated with the requestor computing device 106a, a current direction of travel, and additional active application usage. Additionally, in at least one embodiment, location data also includes specific requestor location data provided by transportation matching system beacons within the venue (e.g., communicating with the requestor computing devices via NFC or other similar technology). The transportation matching system application 110a can access GPS data, gyroscopic data, application usage log data, Wi-Fi data, and so forth to monitor this location data associated with the requestor computing device 106a.

In response to receiving monitored location data from the transportation matching system application 110a on the requestor computing device 106a, the transportation matching system 102 reassess the virtual queue position (312) of the requestor computing device 106a. In one or more embodiments, the transportation matching system 102 operates under a heuristic that dictates the higher a requestor computing device's virtual queue position (e.g., the closer the requestor computing device is to the front of the virtual queue), the closer the requestor computing device is to being transport ready. For example, a requestor computing device is “transport ready” when the requestor computing device is at the pickup location and ready to engage with an available provider computing device. As such, the transportation matching system 102 can reassign the virtual queue position of the requestor computing device 106a in response to determining that the current speed and direction of travel of the requestor computing device 106a indicates the requestor computing device 106a will arrive at the pickup location before another requestor computing device with a higher virtual queue position. Conversely, the transportation matching system 102 can reassign the requestor computing device 106a to a lower virtual queue position in response to determining that the requestor computing device 106a is moving slower than other requestor computing devices in the virtual queue, or in response to determining that the requestor computing device 106a has stopped or changed direction. In at least one embodiment, the transportation matching system 102 can further utilize information associated with the venue, such as a schematic diagram of the venue, to determine that the requestor computing device 106a has stopped in a location that is likely a restroom, shop, or restaurant. Additionally, in at least one embodiment, the transportation matching system 102 can reassign the position of the requestor computing device 106a within the virtual queue based on transportation preferences (e.g., car type, provider ratings) pre-specified by the requestor and available providers.

In addition to constantly reassessing and reassigning virtual queue positions for each requestor computing device in the virtual queue, the transportation matching system 102 also monitors the pickup location (314). In one or more embodiments, the transportation matching system 102 monitors the pickup location (314) to determine how quickly provider computing devices move through the pickup positions at the pickup location, and to determine how long requestor computing devices provided with requestor identifiers wait prior to engaging with an available provider computing device. For example, it is possible that provider computing devices experience longer than average travel time in moving from the staging lot to the pickup location—possibly due to unfavorable traffic conditions and/or pedestrian crowding. In at least one embodiment, the transportation matching system 102 takes through-put of requestor computing devices and provider computing devices at the pickup location into account when providing requestor identifiers to requestor computing devices in the virtual queue.

It follows that along with monitoring the pickup location (314), the transportation matching system 102 also monitors available provider computing devices (316). In one or more embodiments, the transportation matching system 102 determines any provider computing device located in the staging lot to be available to requestor computing devices at the pickup location and in the virtual queue. Additionally, in at least one embodiment, the transportation matching system 102 also monitors provider computing devices located within a threshold distance from the venue.

After monitoring the pickup location (314) and the available providers (316) in addition to managing the virtual queue, the transportation matching system 102 determines to provide a requestor identifier (318) to the requestor computing device 106a. In one or more embodiments, the transportation matching system 102 determines to provide a requestor identifier to the requestor computing device 106a based on the virtual queue position of the requestor computing device 106a, the number of requestor computing devices that already have requestor identifiers, and the number of available provider computing devices. By way of example, in response to determining that there are 6 available provider computing devices (e.g., provider computing devices that are either at the staging lot, or already instructed to move to the pickup location), and 3 requestor computing devices with requestor identifiers at the pickup location, the transportation matching system 102 can provide requestor identifiers to the top 3 requestor computing devices in the virtual queue. By providing a requestor identifier upon an available provider being identified, the virtual queue position of the requestor computing device may be enforced without requiring a rigid physical line and/or administration of a physical queue. As such, order can be maintained and requestors may be allowed access to vehicles when both the requestor and the provider are available without requiring the inconvenience and delay of administering a physical queue.

In at least one embodiment, the transportation matching system 102 may expire a requestor identifier that was previously provided to a requestor computing device. For example, in response to continually monitoring location data associated with requestor computing devices that have been provided with requestor identifiers, the transportation matching system 102 may determine that a requestor computing device with a requestor identifier has left the pickup location (e.g., the requestor has gone back into the venue), or is not engaging with an available provider computing device at the pickup location for a threshold amount of time (e.g., the requestor is waiting for another member of their party to exit the venue). In one or more embodiments, in response to determining that a requestor computing device with a requestor identifier has not utilized that requestor identifier within a threshold amount of time (even though there is at least one available provider computing device), the transportation matching system 102 expires the requestor identifier and places the requestor computing device back in the virtual queue. In that embodiment, the transportation matching system 102 can assign a virtual queue position to the requestor computing device that reflects the requestor computing device's current location relative to the pickup location and the current speed and direction of the requestor computing device.

In response to receiving a requestor identifier from the transportation matching system 102, the requestor computing device 106a displays the requestor identifier (320) via the transportation matching system application 110a. For example, the transportation matching system application 110a can display the requestor identifier in a graphical user interface. Additionally or alternatively, the transportation matching system application 110a can display the requestor identifier in a pop-up notification, or lock screen on the requestor computing device 106a.

Following or concurrent with providing a requestor identifier to the requestor computing device 106a, the transportation matching system 102 instructs the provider computing device 108a to move to the pickup location (322). For example, in order to quickly provide transportation to requestors at the venue, the transportation matching system 102 instructs provider computing devices to move from the staging lot to the pickup location at a rate that ensures requestors with requestor identifiers can utilize their requestor identifiers within a threshold amount of time (e.g., 20 seconds). In one or more embodiments, the transportation matching system 102 provides movement instructions to the provider computing device 108a that includes a message stating that the provider computing device 108a should move from the staging lot to the pickup location in order to provide transportation to a waiting and ready requestor. At this point, the transportation matching system 102 has not matched the provider computing device 108a to any requestor computing device. Accordingly, in at least one embodiment, the movement instructions do not include any information identifying any particular requestor.

After the transportation matching system 102 provides a requestor identifier to the requestor computing device 106a and instructs the provider computing device 108a to move to the pickup location, the requestor associated with the requestor computing device 106a provides the requestor identifier to the provider associated with the provider computing device 108a. In one or more embodiments, the requestor provides the requestor identifier to the provider verbally. The transportation matching system application 110d on the provider computing device 108a receives the requestor identifier (324) in response to the provider entering the requestor identifier into a transportation matching system application graphical user display. Alternatively, the provider computing device 108a can receive the requestor identifier (324) in response to a “bump” (e.g., near field communication or NFC), a BLUETOOTH connection, an ultrasonic signal, an SMS message, or a social networking system electronic message.

In response to determining that the provider computing device 108a has received the requestor identifier (324), the transportation matching system 102 automatically matches (326) the transportation request from the requestor computing device 106a to the provider computing device 108a. As discussed above, the transportation matching system 102 typically matches a provider computing device with a transportation request from a requestor computing device prior to instructing the provider computing device to move to the location of the requestor computing device, and in response to determining that the provider computing device is nearest to the requestor computing device. Within the context of a congested venue, the transportation matching system 102 instructs the provider computing device 108a to move to the pickup location, and matches the transportation request from the requestor computing device 106a to the provider computing device 108a after the requestor has provided the requestor identifier to the provider (e.g., likely after the requestor has entered the provider's car).

After matching the transportation request from the requestor computing device 106a to the provider computing device 108a, the transportation matching system 102 provides transportation request information (328) to the provider computing device 108a and to the requestor computing device 106a. For example, the transportation matching system 102 can provide requestor information (e.g., the requestor's name, the requestor's profile picture) and route information associated with the transportation request to the provider computing device 108a. Similarly, the transportation matching system 102 can provide provider information to the requestor computing device 106a including the provider's name, profile picture, and rating. The provider computing device 108a can then continue to fulfill the transportation request.

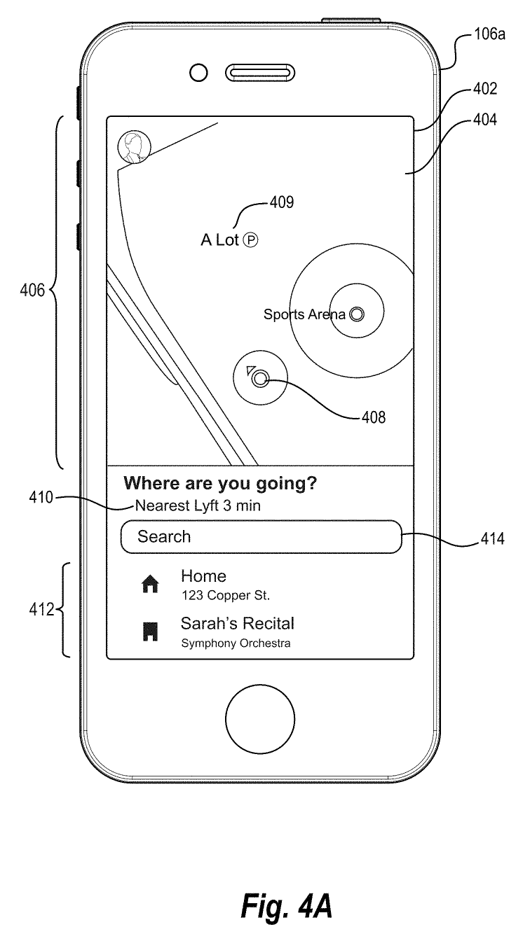

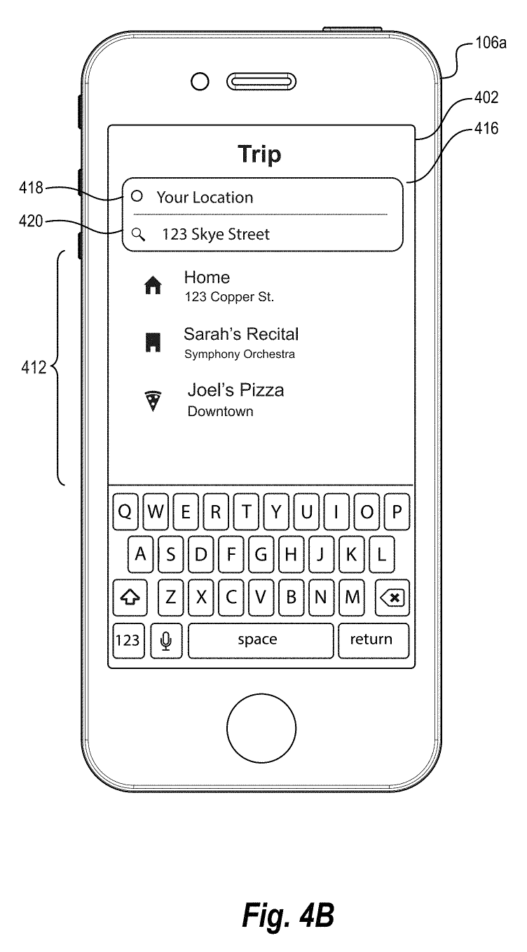

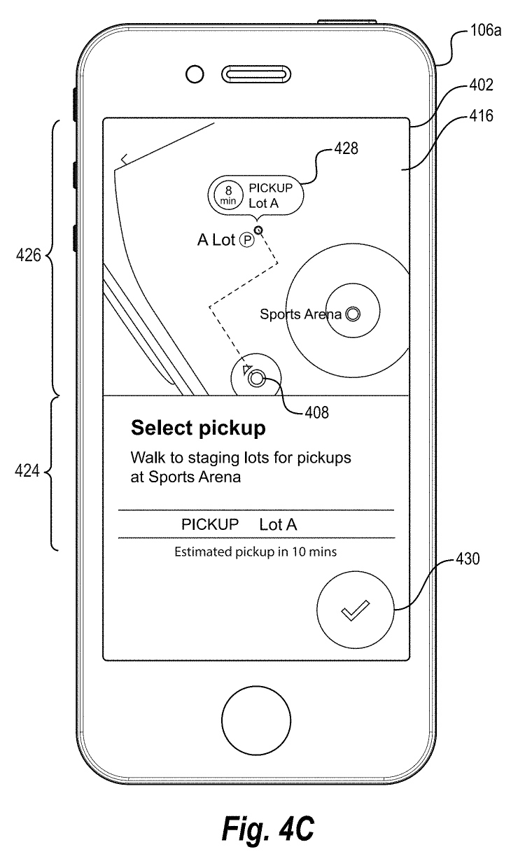

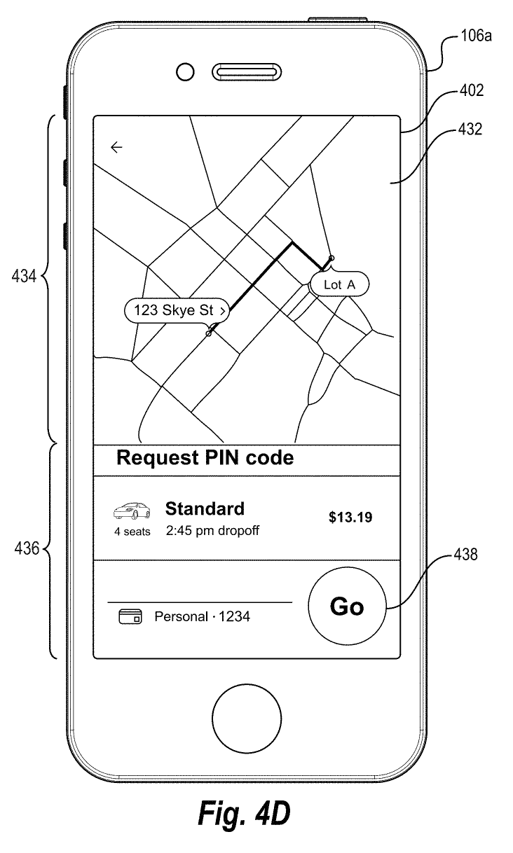

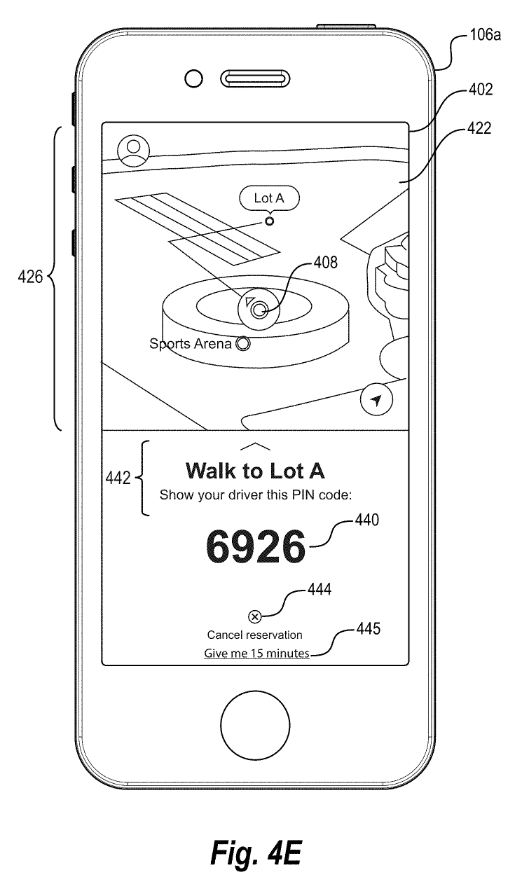

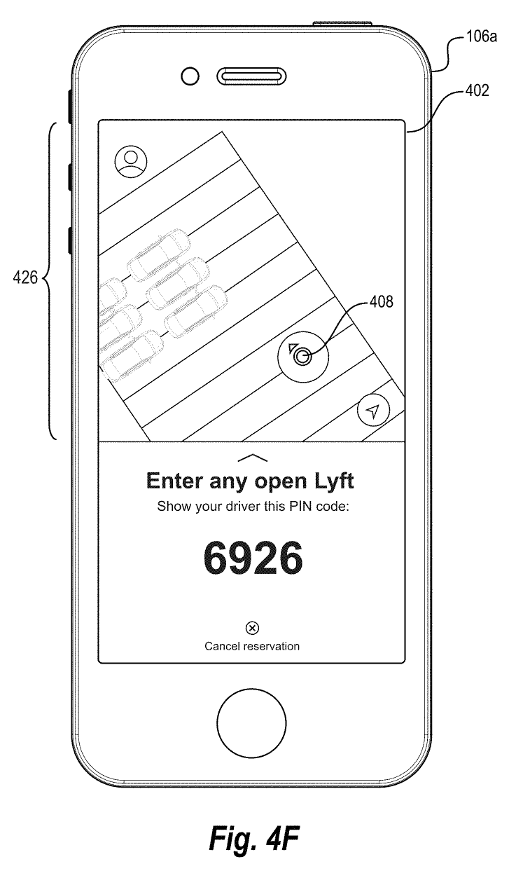

As mentioned above, the transportation matching system 102 (e.g., via the transportation matching system application 110a installed on the requestor computing device 106a) provides one or more graphical user interfaces including display components that enable users to request and receive requestor identifiers in order to quickly and easily engage a provider computing device at a congested venue. FIGS. 4A-6D illustrate a series of graphical user interfaces (GUIs) by which the transportation matching system 102 provides various display components and other features to one or more requestor computing devices. For example, as shown in FIG. 4A, the transportation matching system 102 provides the transportation request configuration GUI 404 on a touch screen display 402 of the requestor computing device 106a. As mentioned above, the transportation matching system 102 provides one or more GUIs and display components via the transportation matching system application 110a installed on the requestor computing device 106a.

For example, as shown in FIG. 4A, the transportation request configuration GUI 404 includes a real-time map 406 showing a current location indicator 408 associated with the requestor computing device 106a. In one or more embodiments, the transportation matching system 102 updates the real-time map 406 in response to receiving an updated location (e.g., based on GPS information, Wi-Fi information) associated with the requestor computing device 106a. In at least one embodiment, the transportation matching system 102 orients the real-time map 406 around the current location indicator 408.

As shown in FIG. 4A, the real-time map 406 can also include a pickup location indicator 409. In one or more embodiments, the pickup location indicator 409 is associated with a single pickup point at the venue. If the venue includes multiple pickup points (e.g., on different streets around the venue, along different sides of the venue), the transportation matching system 102 can dynamically determine a single pickup point to include in the real-time map 406. For example, the transportation matching system 102 can dynamically determine the single pickup point—and provide a corresponding pickup location indicator within the transportation request configuration GUI 404—based on factors including, but not limited to, distance between the requestor and each pickup point, numbers of available providers across all pickup points, and wait time at the nearest pickup point. Thus, the transportation matching system 102 can minimize requestor wait time by dynamically sending the requestor to nearest a pickup point (e.g., via the transportation request configuration GUI 404) where a provider is available.

For example, in one or more embodiments, the transportation matching system 102 associates each pickup location associated with the venue with its own virtual queue. Accordingly, the transportation matching system 102 can move a requestor computing device from one virtual queue to another based on ETAs associated with each pickup location, wait times associated with each pickup location, available providers at each pickup location, and so forth. The transportation matching system 102 may move a requestor computing device from a virtual queue associated with a first pickup location to a virtual queue associated with a second pickup location prior to providing a pickup location indicator with the transportation request configuration GUI 404, in which case the requestor would be unaware of the change. Additionally or alternatively, the transportation matching system 102 may move the requestor computing device from the virtual queue associated with the first pickup location to the virtual queue associated with the second pickup location after providing the pickup location indicator with the transportation request configuration GUI 404. In that case, the transportation matching system 102 may provide a notification (e.g., pop-up window, SMS text message) informing the requestor of the change and the reason (e.g., reduced wait time). Alternatively, the transportation matching system 102 may only move the requestor computing device from the virtual queue associated with the first pickup location to the virtual queue associated with the second pickup location in response to receiving a confirmation from the requestor (e.g., via a confirmation dialog box or similar) to do so.

The transportation request configuration GUI 404 also includes a nearest transport indicator 410, a recent destinations list 412, and a search button 414. In one or more embodiments, the nearest transport indicator 410 informs the user of the requestor computing device 106a how long it will take to engage a provider computing device. In one or more embodiments, the recent destinations list 412 includes one or more destination locations that the requestor has included in recent transportation requests. Additionally or alternatively, the recent destinations list 412 can include one or more destination locations that the requestor frequently includes in transportation requests.

In one or more embodiments, in response to detecting a selection of the search button 414, the transportation matching system 102 enable manual input of a destination location. For example, as shown in FIG. 4B, in response to the detected selection of the search button 414 in the transportation request configuration GUI 404, the transportation matching system 102 provides the destination location configuration GUI 416 on the touch screen display 402 of the requestor computing device 106a. As illustrated in FIG. 4B, the destination location configuration GUI 416 includes a pickup location input box 418, and a destination location input box 420. Additionally, the destination location configuration GUI 416 can also include an expanded recent destinations list 412. In one or more embodiments, the transportation matching system 102 enables the requestor to manually input a pickup location in the pickup location input box 418 (e.g., if the pickup location is somewhere other than the current location of the requestor computing device 106a). Similarly, the transportation matching system 102 enables the requestor to manually input a destination location in the destination location input box 210.

In response to receiving a destination location via the destination location configuration GUI 416, the transportation matching system application 110a installed on the requestor computing device 106a generates a transportation request and sends the generated transportation request to the transportation matching system 102. Upon receiving the transportation request from the requestor computing device 106a, the transportation matching system 102 determines that the requestor computing device 106a is requesting transportation from a congested venue. As discussed above, the transportation matching system 102 can determine that a virtual queue is appropriate for a particular venue in response to determining that the venue has restricted traffic patterns and pickup locations (e.g., as with airports), is hosting an event for more than a threshold number of people (e.g., as with sports events), or is temporarily placing a burden on local resources (e.g., as with a festival in a non-permanent location). Accordingly, in response to receiving the current location of the requestor computing device 106a as part of the transportation request, the transportation matching system 102 determines that the requestor computing device 106a is located at a particular venue. Then, based on Internet searches, internal data (e.g., available driver resources near the venue, number of requests received associated with the venue, etc.), and/or machine learning, in combination with the current time, the transportation matching system 102 can determine that the particular venue is a congested venue.

In response to determining that the requestor computing device 106a is located at a congested venue, the transportation matching system 102 provides access to a virtual queue to the requestor computing device 106a via the transportation matching system application 110a. For example, as shown in FIG. 4C, the transportation matching system 102 provides the anonymous pickup GUI 422 on the touch screen display 402 of the requestor computing device 106a.

As illustrated in FIG. 4C, the anonymous pickup GUI 422 includes a pickup options list 424. In one or more embodiments, if the congested venue includes more than one pickup location, the transportation matching system 102 can list the various pickup locations in the pickup options list 424. For example, the congested venue may include a pickup location associated with standard transportation options (e.g., sedans), and a pickup location associated with luxury transportation options (e.g., SUVs, sports cars). Similarly, the congested venue may include a pickup location associated with standard transportation requests, and a pickup location associated with carpool transportation requests. As shown in FIG. 4C, the pickup options list 424 can include an estimated pickup time associated with each pickup location.

In response to a detected selection of a pickup location from the pickup options list 424, the transportation matching system 102 provides the real-time pickup map 426. In one or more embodiments, the real-time pickup map 426 provides a highlighted route from the current position of the requestor computing device 106a to the selected pickup location. As the requestor computing device 106a moves along the highlighted route, the transportation matching system 102 can update the current location indicator 408 to reflect the requestor's progress along the highlighted route. The transportation matching system 102 can also provide a pickup location indicator 428 in the real-time pickup map 426. In at least one embodiment, the transportation matching system 102 provides an estimate (e.g., in minutes) in the pickup location indicator 428 of how long it will take the requestor computing device 106a to arrive at the pickup location. For example, as the requestor computing device 106a travels along the highlighted route, the transportation matching system 102 can update the pickup location indicator 428 to indicate that the nearing the pickup location.

In some embodiments, at this point, the transportation matching system 102 has not yet added the requestor computing device 106a to the virtual queue. For example, in response to detecting a selection of the check button 430, the transportation matching system 102 provides the confirmation GUI 432, as shown in FIG. 4D. In one or more embodiments, the confirmation GUI 432 includes the route overview 434 (e.g., illustrating the route from the selected pickup location to the destination location), and the transport options 436 (e.g., the desired type of transport, the payment method). In response to a detected selection of the go button 438, a request is sent to the transportation matching system 102 and the transportation matching system 102 can add the requestor computing device 106a to the virtual queue. In some embodiments, the transportation matching system 102 may add the requestor computing device 106a to the virtual queue upon the opening of the transportation matching system application and/or in response to any indication of an intent to initiate a request by the requestor computing device 106a.

After adding the requestor computing device 106a to the virtual queue, the transportation matching system 102 receives updated location data from the requestor computing device 106a. The transportation matching system 102 then updates the virtual queue position of the requestor computing device 106a and provides a requestor identifier to the requestor computing device 106a once the queue position of requestor computing device 106a is sufficiently near to the front of virtual queue and a provider computing device is available, in the manner described above. For example, as shown in FIG. 4E, based on the virtual queue position of the requestor computing device 106a, the number of already issued requestor identifiers, and the number of available provider computing devices, the transportation matching system 102 provides the requestor identifier 440 to the requestor computing device 106a.

In one or more embodiments, in response to providing the requestor identifier 440 to the requestor computing device, the transportation matching system 102 can also update portions of the anonymous pickup GUI 422. For example, the transportation matching system 102 can provide a perspective view of the real-time pickup map 426. Additionally, the transportation matching system 102 can update the real-time pickup map 426 around the current location indicator 408 as the requestor computing device 106a moves along the highlighted route to the pickup location. Furthermore, the transportation matching system 102 can provide instructions 442 specific to the pickup location.

In at least one embodiment, the transportation matching system 102 expires the requestor identifier in response to a detected selection of the cancel button 444. For example, the transportation matching system 102 can expire the requestor identifier and cancel the transportation request associated with the requestor computing device 106a in response to the detected selection of the cancel button. Additionally, as shown in FIG. 4E, in response to a detected selection of the extend button 445, the transportation matching system 102 can expire the requestor identifier and move the requestor computing device 106a back into the virtual queue.

In response to determining that the requestor computing device 106a is within a threshold distance of the pickup location, the transportation matching system 102 can provide additional granularity within the real-time pickup map 426. For example, as shown in FIG. 4F, once the requestor computing device 106a is within a threshold distance (e.g., 100 feet) from the pickup location, the transportation matching system 102 zooms in on the real-time pickup map 426 such that individual providers (e.g., cars) are visible. Alternatively, in at least one embodiment, the transportation matching system 102 can geofence the pickup location. In that embodiment, the transportation matching system 102 can provide the zoomed in view of the real-time pickup map 426 in response to determining that the requestor computing device 106a is within the geofence.

While the transportation matching system 102 generally utilizes a network connection (e.g., a cellular network, a Wi-Fi network) to send and receive data in connection with the requestor computing device 106a, the transportation matching system 102 can also function in a no-connectivity context. For example, if the congested venue is a festival in a temporary rural location, cellphone towers servicing the area may be overwhelmed and unable to provide access to the number of people at the festival. In one or more embodiments, in response to determining that the requestor computing device 106a has insufficient network connectivity, the transportation matching system 102 can utilize near field communication (e.g., BLUETOOTH) to provide a virtual queue.

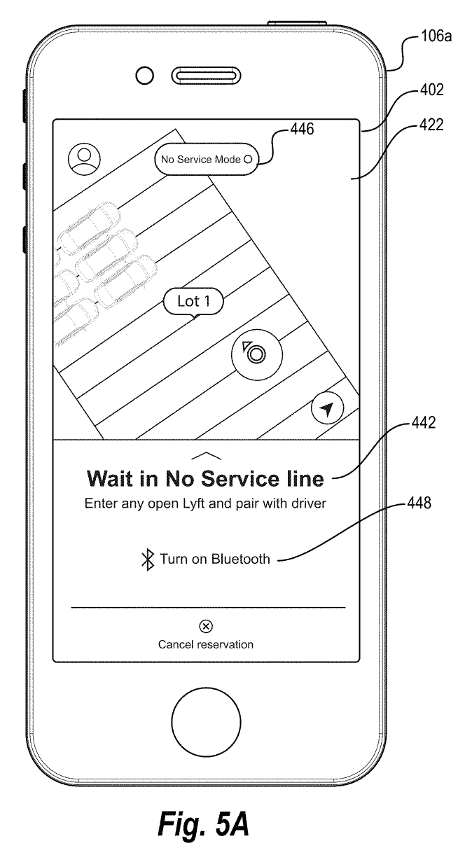

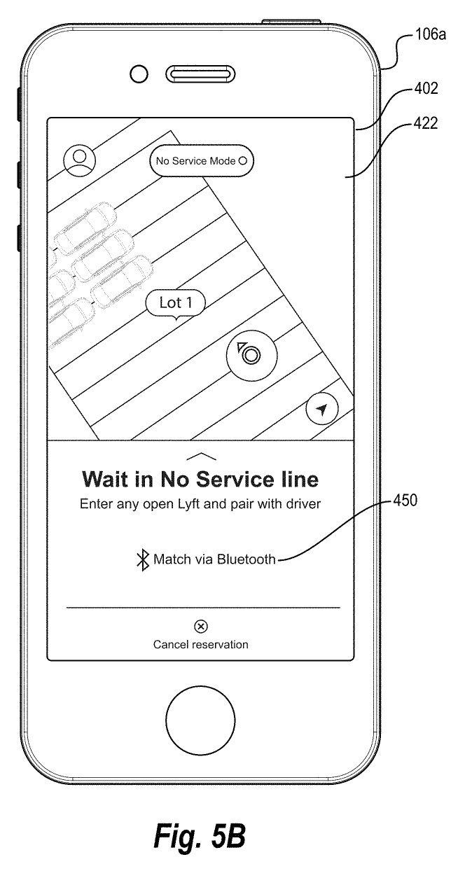

For example, as shown in FIG. 5A, in response to determining that the requestor computing device 106a is experiencing low or no connectivity, the transportation matching system 102 switches the transportation matching system application 110a installed on the requestor computing device 106a to “No Service Mode,” and provides the no service mode indicator 446 in the anonymous pickup GUI 422. In “No Service Mode,” the transportation matching system 102 supersedes the virtual queue, and updates the instructions 442 to instruct the requestor to wait in a “No Service Line.” Additionally, the transportation matching system 102 provides the BLUETOOTH button 448. In response to a detected selection of the BLUETOOTH button 448, the transportation matching system application 110a interfaces with the systems on the requestor computing device 106a to enable on-board BLUETOOTH functionality.

Once at the front of the No Service Line, the requestor can engage with any available provider in the pickup location and pair the requestor computing device 106a to the provider computing device associated with the available provider. For example, as shown in FIG. 5B, in response to determining that the requestor computing device 106a has moved from a geofence around the No Service Line toward a geofence around the pickup location, the transportation matching system 102 can provide the Match via BLUETOOTH button 450 in the anonymous pickup GUI 422. In response to a detected selection of the Match via BLUETOOTH button 450, the transportation matching system 102 identifies a provider computing device within a threshold distance that is also seeking to pair via BLUETOOTH. After pairing the requestor computing device 106a and the provider computing device via BLUETOOTH, the transportation matching system 102 matches the requestor computing device 106a and the provider computing device within the transportation match exchange and provides the transportation request information to the provider computing device, as discussed above.

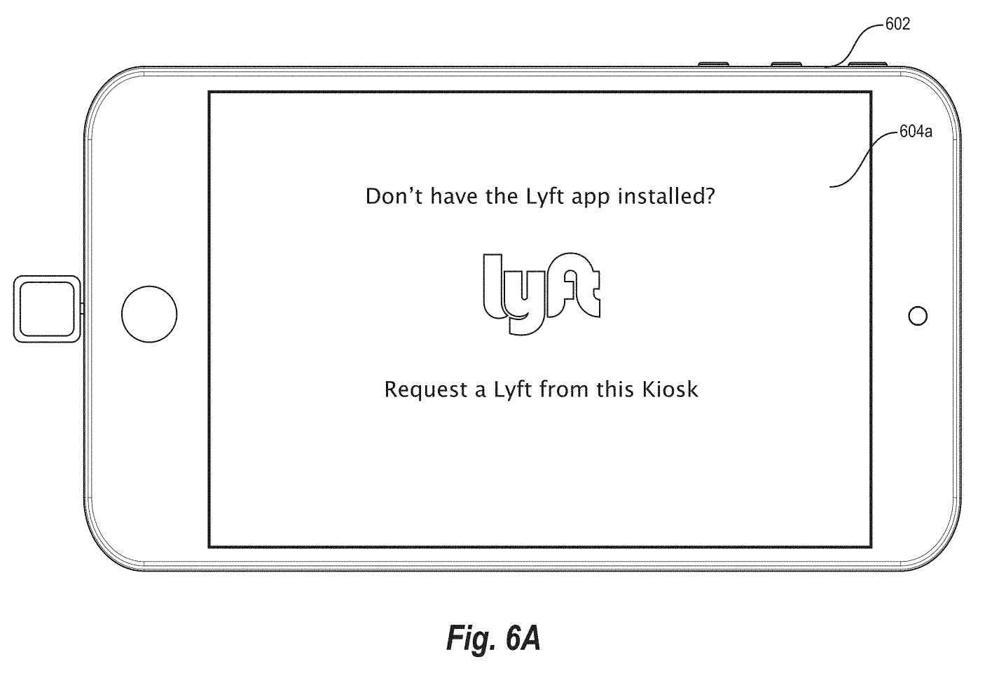

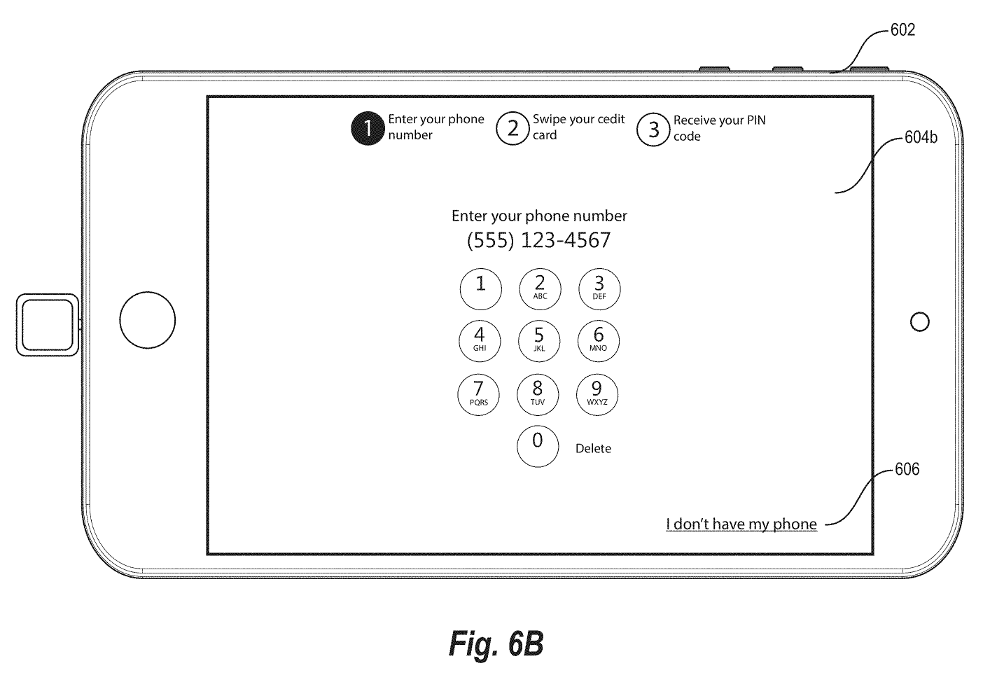

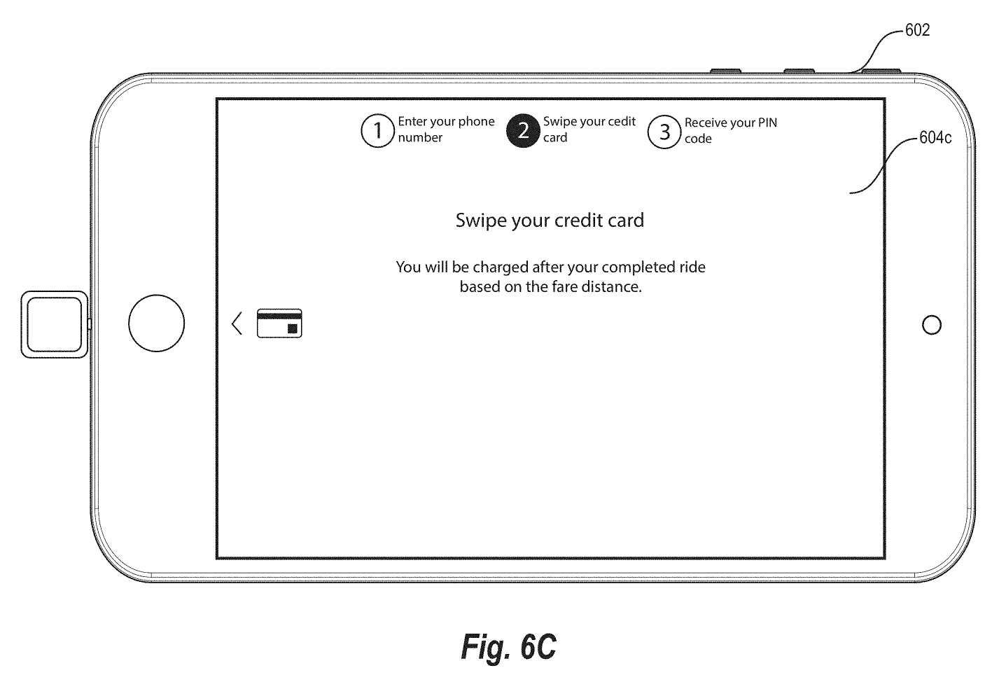

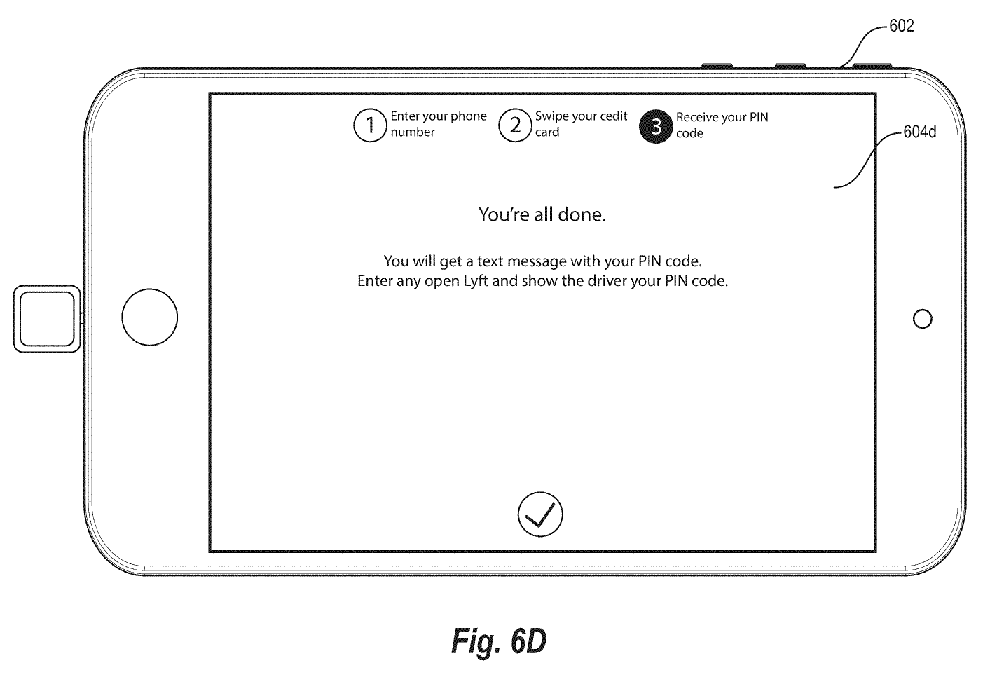

In one or more embodiments, the transportation matching system 102 can provide a virtual queue to requestors who do not have the transportation matching system application installed on their mobile devices. For example, as shown in FIG. 6A, the transportation matching system 102 can provide a virtual queue via a kiosk 602. For instance, the kiosk 602 may be located at or near a pickup location at a congested venue. As illustrated in FIG. 6A, the transportation matching system 102 provides the kiosk GUI 604a on the kiosk 602. In use, a requestor can swipe across the kiosk GUI 604a to begin the virtual queue process.

In response to the detected user interaction with the kiosk GUI 604a, the transportation matching system 102 provides the kiosk GUI 604b on the kiosk 602, as shown in FIG. 6B. In response to the detected input of the requestor's phone number via the kiosk GUI 604b, the transportation matching system 102 provides the kiosk GUI 604c on the kiosk 602, as shown in FIG. 6C. Next, in response to the detected input of the requestor's payment information (e.g., via a magnetic stripe reader, via manual input), the transportation matching system 102 provides the kiosk GUI 604d on the kiosk 602, as shown in FIG. 6D.

In one or more embodiments, in response to receiving a requestor's phone number and payment information, the transportation matching system 102 provides a requestor identifier via SMS to a mobile device associated with the requestor. For example, the transportation matching system 102 can add the requestor's phone number to the virtual queue reassign the virtual queue position of the requestor's phone number based on the requestor's current location (e.g., at the kiosk). The transportation matching system 102 can provide the requestor identifier to the requestor's mobile device, and the requestor can engage any available provider at the pickup location, as described above. In at least one embodiment, because the requestor has not yet configured a transportation request, the provider may have to configure the requestor's transportation request prior to leaving the pickup location.

Alternatively, in at least one embodiment, the requestor may not have a mobile device (e.g., the requestor's mobile phone may have been lost or the battery drained) where the transportation matching system 102 can send a requestor identifier. In that embodiment, the transportation matching system 102 may provide a requestor identifier via the kiosk 602 at the pickup location. For example, the transportation matching system 102 may include a selectable option 606 in the kiosk GUI 604b on the kiosk 602, as shown in FIG. 6B. In response to a detected selection of the selectable option 606, the transportation matching system 102 can receive the requestor's payment information, match the requestor to an available provider, and display a requestor identifier as part of the kiosk GUI 604c on the kiosk 602. The requestor can then verbally provide the requestor identifier to an available provider.

In one or more embodiments, the transportation matching system 102 can provide a kiosk in combination with the transportation matching system application. For example, a venue may include a single pickup location that is inside a structure with poor reception (e.g., a concrete parking structure). In that embodiment, the transportation matching system 102 can determine and provide a requestor identifier to a requestor computing device (e.g., the requestor computing device 106a) as the requestor makes their way to the pickup location (i.e., in the manner described above with regard to FIG. 3). For instance, the transportation matching system 102 may provide the requestor identifier prior to the requestor arriving within the geofence surrounding the pickup location based on prior knowledge of the poor reception at the pickup location.

Once the requestor arrives at the pickup location, the requestor can input the provided requestor identifier into the transportation matching system kiosk (e.g., the kiosk 602 described with reference to FIGS. 6A-6D) installed at the pickup location. Alternatively, the transportation matching system 102 can utilize NFC or other similar techniques to automatically determine that the requestor computing device has arrived at the pickup location near the kiosk. At that point, the transportation matching system 102 can match the transportation request associated with the requestor computing device with an available provider at the pickup location and provide identifying information associated with the provider via the kiosk display and/or directly to the requestor computing device. The requestor can then engage with the identified provider in the manner described above in order for the provider to fulfill the transportation request.

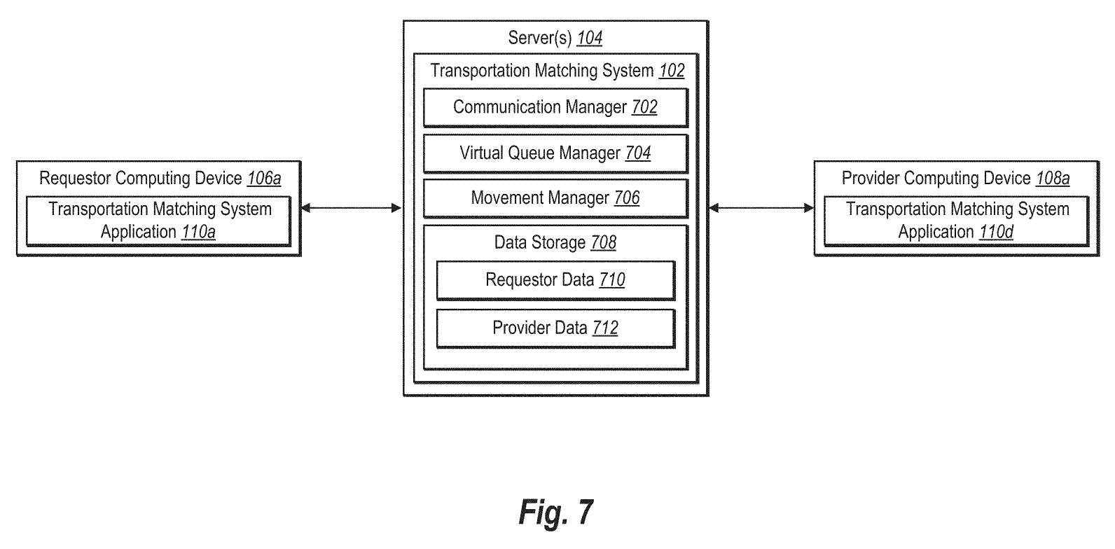

FIG. 7 illustrates a schematic diagram illustrating an example embodiment of the transportation matching system 102 in connection with the requestor computing device 106a and the provider computing device 108a. As shown in FIG. 7, the transportation matching system 102 includes various components for performing the processes and features described herein. For example, as shown in FIG. 7, the transportation matching system 102 includes a communication manager 702, a virtual queue manager 704, a movement manager 706, and a data storage 708 including requestor data 710 and provider data 712. Additionally, the requestor computing device 106a and the provider computing device 108a each include the transportation matching system application 110a, and 110d, respectively.

Each of the components 702-708 of the transportation matching system 102 can be implemented using a computing device including at least one processor executing instructions that cause the performance of the processes described herein. In some embodiments, the components 702-708 of the transportation matching system 102 can be implemented by a single server or across multiple servers. Additionally or alternatively, a combination of one or more server devices and one or more computing devices can implement the components described herein in a different arrangement than illustrated in FIG. 7. Additionally or alternatively, the components described herein can comprise a combination of computer-executable instructions and hardware.

In one or more embodiments, the transportation matching system application 110 (e.g., the transportation matching system application 110a, 110d installed on the requestor computing device 106a and provider computing device 108a, respectively) is a native application. For example, the transportation matching system application 110 can be a mobile application that installs and runs on a mobile device, such as a smart phone, tablet computer, or smart wearable. Alternatively, the transportation matching system application 110 can be a desktop application, widget, or other form of a native computing program. Furthermore, the transportation matching system application 110 may be a remote application accessed by the requestor computing device 106a or provider computing device 108a. For example, the transportation matching system application 110 may be a web application that is executed within a web browser of the requestor computing device 106a or provider computing device 108a.

In one or more embodiments, the transportation matching system application 110 enables a requestor or provider to interact with one or more features of the transportation matching system 102. For example, a requestor can utilize the transportation matching system application 110a to configure and send a transportation request to the transportation matching system 102. Further, a provider can utilize the transportation matching system application 110d to view and accept movement instructions provided by the transportation matching system 102.

Furthermore, the transportation matching system application 110 monitors other activity associated with the requestor computing device 106a and with the provider computing device 108a. For example, the transportation matching system application 110a monitors location information (e.g., GPS information, Wi-Fi information, gyroscopic information) to determine the current location, and direction and speed of travel of the requestor computing device 106a. Similarly, the transportation matching system application 110d monitors the same information to determine the current location, and direction and speed of travel of the provider computing device 108a. In one or more embodiments, the transportation matching system application 110 provides this monitored activity information to the transportation matching system 102.

In one or more embodiments, the transportation matching system application 110 also receives information from the transportation matching system 102. For example, the transportation matching system application 110a can receive and display a requestor identifier from the transportation matching system 102. Additionally, the transportation matching system application 110d can receive and display movement instructions from the transportation matching system 102.

As illustrated in FIG. 7, and as mentioned above, the transportation matching system 102 includes the communication manager 702. In one or more embodiments, the communication manager 702 handles the sending and receiving of information to and from requestor computing devices and provider computing devices. For example, the communication manager 702 receives location information from the requestor computing device 106a and provides a requestor identifier to the requestor computing device 106a. Similarly, the communication manager 702 receives location information from the provider computing device 108a and provides movement instructions to the provider computing device 108a.

Furthermore, as shown in FIG. 7, and as mentioned above, the transportation matching system 102 includes the virtual queue manager 704. In one or more embodiments, the virtual queue manager 704 initializes a virtual queue in connection with a congested venue. For example, as discussed above, the virtual queue manager 704 determines that a particular venue during a particular time frame is a congested venue based on requestor volume, anticipated event attendance, and pickup location constraints. In response to determining that a particular venue is a congested venue, the virtual queue manager 704 initializes and manages a virtual queue associated with the congested venue.

Additionally, the virtual queue manager 704 adds requestor computing devices to the virtual queue. For example, as discussed above, in response to receiving a transportation request from a requestor computing device, the virtual queue manager 704 adds the requestor computing device to the virtual queue associated with the congested venue where the requestor computing device is located. Initially, the virtual queue manager 704 adds requestor computing devices to the virtual queue in the order that their associated transportation requests are received by the transportation matching system 102.

Furthermore, the virtual queue manager 704 assigns and reassigns virtual queue positions to the requestor computing devices in the virtual queue. For example, the virtual queue manager 704 can analyze location data associated with a requestor computing device in the virtual queue to determine the current location, and travel speed and direction associated with the requestor computing device. Moreover, the virtual queue manager 704 can utilize venue maps and schematics to determine whether the requestor computing device has stopped in a restroom, shop, or restaurant. Based on these determinations, the virtual queue manager 704 can assign or reassign the virtual queue position of the requestor computing device to a higher or lower position in the virtual queue. In at least one embodiment, the virtual queue manager 704 compares the location and travel speed of a requestor computing device against that of other requestor computing devices in the virtual queue such that the virtual queue position of each requestor computing device roughly approximates every requestor computing device's distance from the congested venue's pickup location.

In one or more embodiments, the virtual queue manager 704 also determines when to provide a requestor identifier to a requestor computing device in the virtual queue. For example, as discussed above, the virtual queue manager 704 can determine to provide a requestor identifier to a requestor computing device based on the virtual queue position of the requestor computing device, on the number of requestor computing devices that have already been provided with requestor identifiers, and on the number of available provider computing devices.

Furthermore, the virtual queue manager 704 provides requestor identifiers to requestor computing devices. For example, based on the determination described above, the virtual queue manager 704 generates a unique four-digit number and provides the generated number to a requestor computing device. In at least one embodiment, the virtual queue manager 704 tracks an amount of time between when a requestor identifier is provided and when the same requestor identifier is received again. If a requestor identifier is not received within a threshold amount of time from when it was provided, the virtual queue manager 704 can expire the requestor identifier. In response to expiring a requestor identifier, the virtual queue manager 704 can add the associated requestor computing device back into the virtual queue.

Additionally, as shown in FIG. 7, and as mentioned above, the transportation matching system 102 includes the movement manager 706. In one or more embodiments, the movement manager 706 forecasts provider need at the pickup location associated with a congested venue. For example, the movement manager 706 can forecast provider need based on historical requestor activity at the venue during the same time window. The movement manager 706 can also forecast provider need based on real-time requestor activity information.

In one or more embodiments, the movement manager 706 also provides movement instructions to provider computing devices. For example, the movement manager 706 can provide movement instructions to provider computing devices within a threshold distance of the congested venue to the staging lot associated with the congested venue. Furthermore, in response to the number of requestor identifiers provided to requestor computing devices in the virtual queue, the movement manager 706 also provides movement instructions to provider computing devices to move from the staging lot to the pickup location associated with the congested venue.

Furthermore, the movement manager 706 also automatically matches transportation requests to provider computing devices. For example, as discussed above, after receiving a requestor identifier, a requestor can engage any available provider at the pickup location by providing the requestor identifier to the provider (e.g., verbally, via NFC, via SMS). The provider then submits the requestor identifier to the transportation matching system 102 via a provider computing device. In response to receiving the requestor identifier from the provider computing device, the movement manager 706 bypasses the typical location-based matching process, and automatically matches the transportation request associated with the requestor computing device to the provider computing device that submitted the requestor identifier.

After matching the transportation request to the provider computing device, the movement manager 706 can provide additional information to both the requestor computing device and the provider computing device. For example, the movement manager 706 can provide information associated with the provider computing device (e.g., identifying information, rating information) to the requestor computing device. Similarly, the movement manager 706 can provide information associated with the transportation request (e.g., route information, destination information), and with the requestor computing device (e.g., identifying information) to the provider computing device.

As further shown in FIG. 7, the transportation matching system 102 also includes the data storage 708 including requestor data 710 and provider data 712. In one or more embodiments, requestor data 710 includes requestor computing device information such as described herein. Also in one or more embodiments, provider data 712 includes provider computing device information such as described herein.

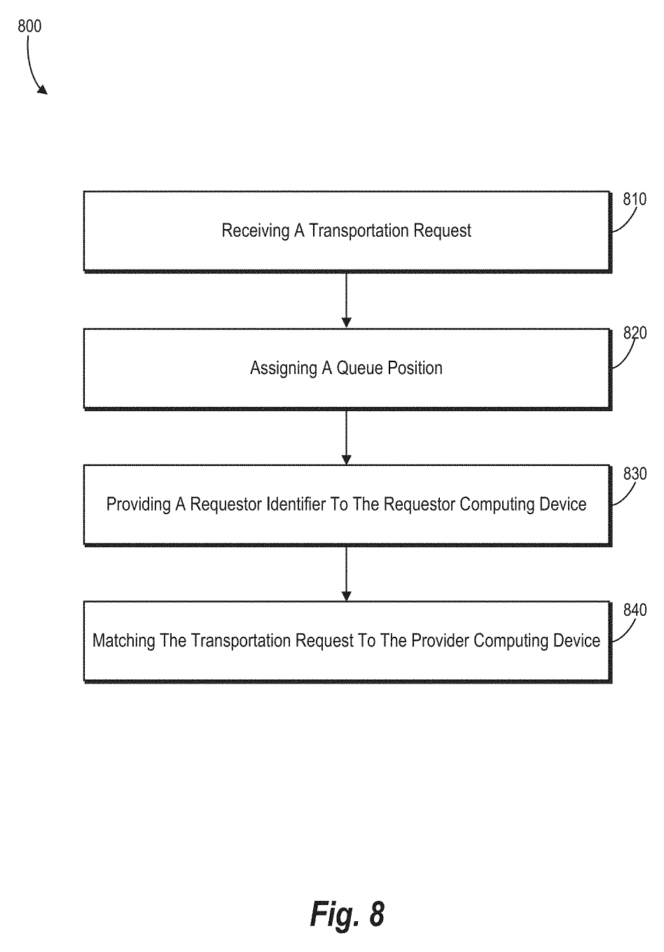

Turning now to FIG. 8, this figure illustrates a flowchart of a series of acts 800 of providing a virtual queue in connection with a congested venue. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer-readable medium can comprise instructions, that when executed by one or more processors, cause a computing device to perform the acts of FIG. 8. In still further embodiments, a system can perform the acts of FIG. 8.

As shown in FIG. 8, the series of acts 800 includes an act 810 receiving a transportation request. For example, the act 810 can involve receiving, by a transportation matching system, a transportation request from a requestor computing device associated with a venue. In one or more embodiments, a venue includes one or more pickup locations and a current location of the requestor computing device corresponds with the venue and is different from any of the one or more pickup locations.

The series of acts 800 further includes an act 820 of assigning a queue position. For example, the act 820 can involve assigning, in response to receiving the transportation request, a queue position to the requestor computing device based at least in part on location data associated with the requestor computing device and an estimated time of arrival for the requestor computing device at a pickup location associated with the venue. In one or more embodiments, assigning the queue position to the requestor computing device includes: determining, based on the location data associated with the requestor computing device, a current location of the requestor computing device relative to the pickup location associated with the venue; determining, based at least in part on the current location of the requestor computing device, the estimated time of arrival for the requestor computing device at the pickup location associated with the venue; and assigning, based on the determined estimated time of arrival, the queue position to the requestor computing device. In at least one embodiment, determining the estimated time of arrival associated with the requestor computing device relative to the pickup location associated with the venue is based on one or more of a travel speed associated with the requestor computing device, a direction of travel associated with the requestor computing device, or a distance between the current location of the requestor computing device and the pickup location associated with the venue.

In one or more embodiments, the series of acts 800 includes acts of: receiving, from the requestor computing device prior to providing the requestor identifier, updated location data associated with the requestor computing device; analyzing the updated location data associated with the requestor computing device to determine an updated estimated time of arrival for the requestor computing device at the pickup location associated with the venue; adjusting the queue position of the requestor computing device based on the updated estimated time of arrival; and wherein providing the requestor identifier to the requestor computing device is based on the adjusted queue position of the requestor computing device and an availability of at least one provider computing device.

In one or more embodiments, the series of acts 800 also includes acts of: analyzing an activity history associated with the venue to determine a historical average ETA; and wherein assigning the queue position to the requestor computing device is further based on the historical average ETA.

Furthermore, the series of acts 800 includes an act 830 of providing a requestor identifier to a requestor computing device. For example, the act 830 can involve providing, based on the assigned queue position, a requestor identifier to the requestor computing device that is configured to initiate a match with a provider computing device. In one or more embodiments, the series of acts 800 includes an act of determining when to provide the requestor identifier based on: determining a number of currently issued requestor identifiers; determining a number of currently available provider computing devices; and determining a current queue position of the requestor computing device.

Additionally, the series of acts 800 includes an act 840 of matching the transportation request to the provider computing device. For example, the act 840 can involve, in response to receiving the requestor identifier from a provider computing device, matching the transportation request to the provider computing device.

In additional embodiments, the series of acts 800 includes an act of determining a number of pickup positions within the pickup location associated with the venue, wherein determining when to provide the requestor identifier to the requestor computing device is further based on the number of pickup positions associated with the venue.

Furthermore, in at least one embodiment, the series of acts 800 includes acts of: determining a wait time associated with a queue associated with an additional pickup location of the venue is less than a present wait time associated with the requestor computing device's queue position; in response to the determination, assigning the requestor computing device a queue position in the queue associated with the additional pickup location; and generating a notification related to the additional pickup location.

Additionally, in at least one embodiment, the series of acts 800 includes acts of: providing the requestor identifier to the requestor computing device; determining, after a threshold amount of time, that the requestor identifier has not been received from a provider computing device; and expiring the requestor identifier provided to the requestor computing device. Moreover, in at least one embodiment, the series of acts 800 includes acts of: providing the requestor identifier to the requestor computing device; determining, based on an analysis of updated location data associated with the requestor computing device, that the requestor computing device is moving away from the pickup location associated with the venue; and expiring the requestor identifier provided to the requestor computing device.

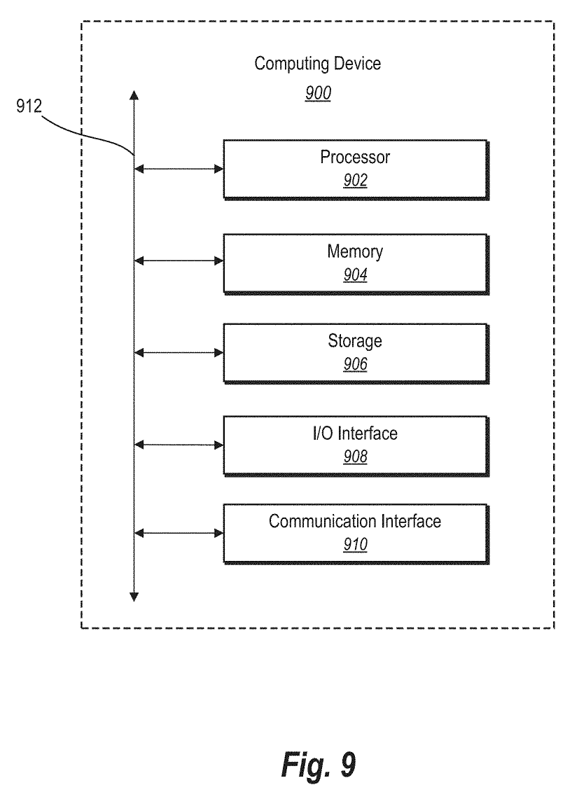

FIG. 9 shows an example computing device 900, in accordance with various embodiments. In one or more embodiments, the computing device 900 may be used to implement any of the systems, devices, or methods described herein. In some embodiments, the computing device 900 may correspond to any of the various devices described herein, including, but not limited to, mobile devices, tablet computing devices, wearable devices, personal or laptop computers, vehicle-based computing devices, or other devices or systems described herein. As shown in FIG. 9, the computing device 900 can include various subsystems connected by a bus 902. The subsystems may include an I/O device subsystem 904, a display device subsystem 906, and a storage subsystem 910 including one or more computer readable storage media 908. The subsystems may also include a memory subsystem 912, a communication subsystem 920, and a processing subsystem 922.

In the computing device 900, the bus 902 facilitates communication between the various subsystems. Although a single bus 902 is shown, alternative bus configurations may also be used. The bus 902 may include any bus or other component to facilitate such communication as is known to one of ordinary skill in the art. Examples of such bus systems may include a local bus, parallel bus, serial bus, bus network, and/or multiple bus systems coordinated by a bus controller. The bus 902 may include one or more buses implementing various standards such as Parallel ATA, serial ATA, Industry Standard Architecture (ISA) bus, Extended ISA (EISA) bus, MicroChannel Architecture (MCA) bus, Peripheral Component Interconnect (PCI) bus, or any other architecture or standard as is known in the art.

In some embodiments, the I/O device subsystem 904 may include various input and/or output devices or interfaces for communication with such devices. Such devices may include, without limitation, a touch screen display or other touch-sensitive input device, a keyboard, a mouse, a trackball, a motion sensor or other movement-based gesture recognition device, a scroll wheel, a click wheel, a dial, a button, a switch, audio recognition devices configured to receive voice commands, microphones, image capture based devices such as eye activity monitors configured to recognize commands based on eye movement or blinking, and other types of input devices. The I/O device subsystem 904 may also include identification or authentication devices, such as fingerprint scanners, voiceprint scanners, iris scanners, or other biometric sensors or detectors. In various embodiments, the I/O device subsystem 904 may include audio output devices, such as speakers, media players, or other output devices.

The computing device 900 may include a display device subsystem 906. The display device subsystem 906 may include one or more lights, such as one or more light emitting diodes (LEDs), LED arrays, a liquid crystal display (LCD) or plasma display or other flat-screen display, a touch screen, a head-mounted display or other wearable display device, a projections device, a cathode ray tube (CRT), and any other display technology configured to visually convey information. In various embodiments, the display device subsystem 906 may include a controller and/or interface for controlling and/or communicating with an external display, such as any of the above-mentioned display technologies.

As shown in FIG. 9, the computing device 900 may include the storage subsystem 910 including various computer readable storage media 908, such as hard disk drives, solid state drives (including RAM-based and/or flash-based SSDs), or other storage devices. In one or more embodiments, the computer readable storage media 908 is configurable to store software, including programs, code, or other instructions, that is executable by a processor to provide functionality described herein. In some embodiments, the storage subsystem 910 may include various data stores or repositories or interface with various data stores or repositories that store data used with embodiments described herein. Such data stores may include, databases, object storage systems and services, data lakes or other data warehouse services or systems, distributed data stores, cloud-based storage systems and services, file systems, and any other data storage system or service. In some embodiments, the storage subsystem 910 can include a media reader, card reader, or other storage interface to communicate with one or more external and/or removable storage devices. In various embodiments, the computer readable storage media 908 can include any appropriate storage medium or combination of storage media. For example, the computer readable storage media 908 can include, but is not limited to, any one or more of random access memory (RAM), read only memory (ROM), electronically erasable programmable ROM (EEPROM), flash memory or other memory technology, optical storage (e.g., CD-ROM, DVD, Blu-ray® disk or other optical storage device), magnetic storage (e.g., tape drives, cassettes, magnetic disk storage or other magnetic storage devices). In some embodiments, the computer readable storage media 908 can include data signals or any other medium through which data can be sent and/or received.

The memory subsystem 912 can include various types of memory, including RAM, ROM, flash memory, or other memory. The memory subsystem 912 can include SRAM (static RAM) or DRAM (dynamic RAM). In some embodiments, the memory subsystem 912 can include a BIOS (basic input/output system) or other firmware configured to manage initialization of various components during for example startup. As shown in FIG. 9, the memory subsystem 912 can include applications 914 and application data 916. The applications 914 may include programs, code, or other instructions, that can be executed by a processor. The applications 914 can include various applications such as browser clients, location management applications, ride management applications, data management application, and any other application. The application data 916 can include any data produced and/or consumed by the applications 914. The memory subsystem 912 can additionally include operating system, such as macOS®, Windows®, Linux®, various UNIX® or UNIX- or Linux-based operating systems or other operating systems.

The computing device 900 can also include a communication subsystem configured to facilitate communication between the computing device 900 and various external computer systems and/or networks (such as the Internet, a LAN, a WAN, a mobile network, or any other network). The communication subsystem can include hardware and/or software to enable communication over various wired (such as Ethernet or other wired communication technology) or wireless communication channels, such as radio transceivers to facilitate communication over wireless networks, mobile or cellular voice and/or data networks, Wi-Fi networks, or other wireless communication networks. Additionally or alternatively, the communication subsystem can include hardware and/or software components to communicate with satellite-based or ground-based location services, such as GPS (global positioning system). In some embodiments, the communication subsystem may include, or interface with, various hardware or software sensors. The sensors may be configured to provide continuous and/or periodic data or data streams to a computer system through the communication subsystem.

As shown in FIG. 9, the processing subsystem can include one or more processors or other devices operable to control the computing device 900. Such processors can include the single core processors, multi-core processors, which can include central processing units (CPUs), graphical processing units (GPUs), application specific integrated circuits (ASICs), digital signal processors (DSPs) or any other generalized or specialized microprocessor or integrated circuit. Various processors within processing subsystem may be used independently or in combination depending on the application

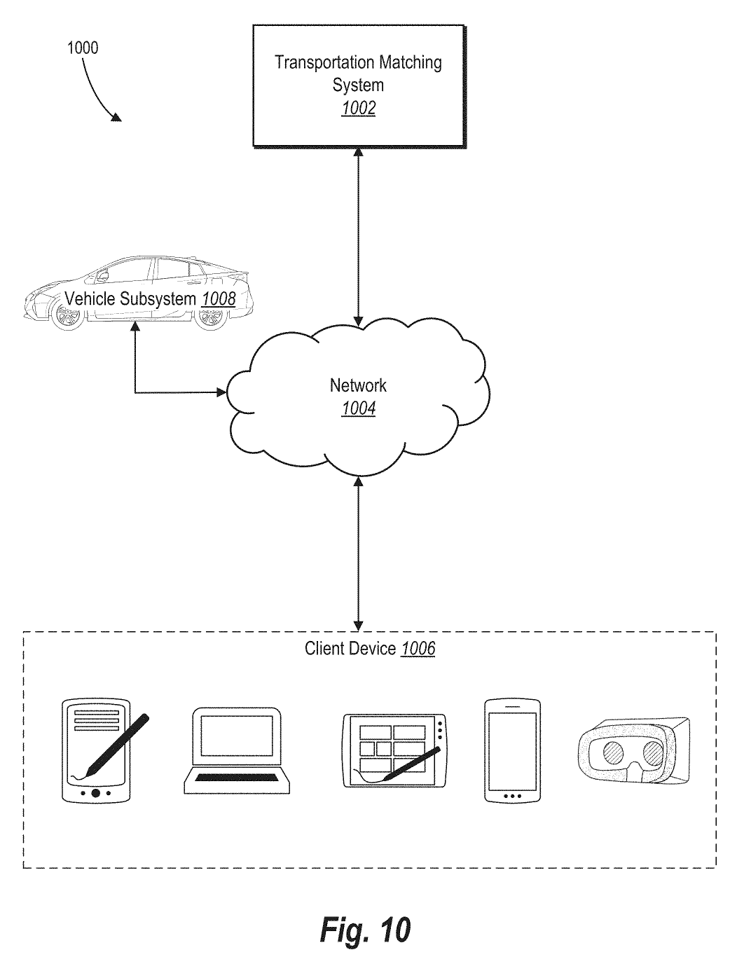

FIG. 10 illustrates an example network environment 1000 of a transportation matching system (e.g., the transportation matching system 102). The network environment 1000 includes a client device 1006, a transportation matching system 1002, and a vehicle subsystem 1008 connected to each other by a network 1004. Although FIG. 10 illustrates a particular arrangement of the client device 1006, the transportation matching system 1002, the vehicle subsystem 1008, and the network 1004, this disclosure contemplates any suitable arrangement of the client device 1006, the transportation matching system 1002, the vehicle subsystem 1008, and the network 1004. As an example, and not by way of limitation, two or more of the client device 1006, the transportation matching system 1002, and the vehicle subsystem 1008 communicate directly, bypassing the network 1004. As another example, two or more of the client device 1006, the transportation matching system 1002, and the vehicle subsystem 1008 may be physically or logically co-located with each other in whole or in part. Moreover, although FIG. 10 illustrates a particular number of the client devices 1006, the transportation matching systems 1002, the vehicle subsystems 1008, and the networks 1004, this disclosure contemplates any suitable number of the client devices 1006, the transportation matching systems 1002, the vehicle subsystems 1008, and the networks 1004. As an example, and not by way of limitation, the network environment 1000 may include multiple client devices 1006, the transportation matching systems 1002, the vehicle subsystems 1008, and the networks 1004.

This disclosure contemplates any suitable network 1004. As an example, and not by way of limitation, one or more portions of the network 1004 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. The network 1004 may include one or more networks 1004.

Links may connect the client device 1006, the transportation matching system 1002, and the vehicle subsystem 1008 to the communication network 1004 or to each other. This disclosure contemplates any suitable links. In particular embodiments, one or more links include one or more wireline (such as for example Digital Subscriber Line (DSL) or Data Over Cable Service Interface Specification (DOCSIS), wireless (such as for example Wi-Fi or Worldwide Interoperability for Microwave Access (WiMAX), or optical (such as for example Synchronous Optical Network (SONET) or Synchronous Digital Hierarchy (SDH) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by the client device 1006. As an example, and not by way of limitation, a client device 1006 may include any of the computing devices discussed above in relation to FIG. 8. A client device 1006 may enable a network user at the client device 1006 to access a network. A client device 1006 may enable its user to communicate with other users at other client systems or devices.

In particular embodiments, the client device 1006 may include a transportation service application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1006 may enter a Uniform Resource Locator (URL) or other address directing the web browser to a particular server (such as server), and the web browser may generate a Hyper Text Transfer Protocol (HTTP) request and communicate the HTTP request to server. The server may accept the HTTP request and communicate to client device 1006 one or more Hyper Text Markup Language (HTML) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the transportation matching system 1002 may be a network-addressable computing system that can host a ride share transportation network. The transportation matching system 1002 may generate, store, receive, and send data, such as, for example, user-profile data, concept-profile data, text data, ride request data, GPS location data, provider data, requester data, vehicle data, or other suitable data related to the ride share transportation network. This may include authenticating the identity of providers and/or vehicles who are authorized to provide ride services through the transportation matching system 1002. In addition, the transportation service system may manage identities of service requestors such as users/requesters. In particular, the transportation service system may maintain requester data such as driving/riding histories, personal data, or other user data in addition to navigation and/or traffic management services or other location services (e.g., GPS services).

In particular embodiments, the transportation matching system 1002 may manage ride matching services to connect a user/requester with a vehicle and/or provider. By managing the ride matching services, the transportation matching system 1002 can manage the distribution and allocation of vehicle subsystem resources and user resources such as GPS location and availability indicators, as described herein.

The transportation matching system 1002 may be accessed by the other components of the network environment 1000 either directly or via network 1004. In particular embodiments, the transportation matching system 1002 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 1002 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or a transportation matching system 1002 to manage, retrieve, modify, add, or delete, the information stored in data store.

In particular embodiments, the transportation matching system 1002 may provide users with the ability to take actions on various types of items or objects, supported by the transportation matching system 1002. As an example, and not by way of limitation, the items and objects may include ride share networks to which users of the transportation matching system 1002 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 1002 or by an external system of a third-party system, which is separate from the transportation matching system 1002 and coupled to the transportation matching system 1002 via a network 1004.

In particular embodiments, the transportation matching system 1002 may be capable of linking a variety of entities. As an example, and not by way of limitation, the transportation matching system 1002 may enable users to interact with each other or other entities, or to allow users to interact with these entities through an application programming interfaces (API) or other communication channels.

In particular embodiments, the transportation matching system 1002 may include a variety of servers, sub-systems, programs, modules, logs, and data stores. In particular embodiments, the transportation matching system 1002 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The transportation matching system 1002 may also include suitable components such as network interfaces, security mechanisms, load balancers, failover servers, management-and-network-operations consoles, other suitable components, or any suitable combination thereof. In particular embodiments, the transportation matching system 1002 may include one or more user-profile stores for storing user profiles. A user profile may include, for example, biographic information, demographic information, behavioral information, social information, or other types of descriptive information, such as work experience, educational history, hobbies or preferences, interests, affinities, or location.

The web server may include a mail server or other messaging functionality for receiving and routing messages between the transportation matching system 1002 and one or more client devices 1006. An action logger may be used to receive communications from a web server about a user's actions on or off the transportation matching system 1002. In conjunction with the action log, a third-party-content-object log may be maintained of user exposures to third-party-content objects. A notification controller may provide information regarding content objects to a client device 1006. Information may be pushed to a client device 1006 as notifications, or information may be pulled from the client device 1006 responsive to a request received from the client device 1006. Authorization servers may be used to enforce one or more privacy settings of the users of the transportation matching system 1002. A privacy setting of a user determines how particular information associated with a user can be shared. The authorization server may allow users to opt in to or opt out of having their actions logged by the transportation matching system 1002 or shared with other systems, such as, for example, by setting appropriate privacy settings. Third-party-content-object stores may be used to store content objects received from third parties. Location stores may be used for storing location information received from the client devices 1006 associated with users.

In addition, the vehicle subsystem 1008 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 1008 can include an autonomous vehicle—i.e., a vehicle that does not require a human operator. In these embodiments, the vehicle subsystem 1008 can perform maneuvers, communicate, and otherwise function without the aid of a human provider, in accordance with available technology.

In particular embodiments, the vehicle subsystem 1008 may include one or more sensors incorporated therein or associated thereto. For example, sensor(s) can be mounted on the top of the vehicle subsystem 1008 or else can be located within the interior of the vehicle subsystem 1008. In certain embodiments, the sensor(s) can be located in multiple areas at once—i.e., split up throughout the vehicle subsystem 1008 so that different components of the sensor(s) can be placed in different locations in accordance with optimal operation of the sensor(s). In these embodiments, the sensor(s) can include a LIDAR sensor and an inertial measurement unit (IMU) including one or more accelerometers, one or more gyroscopes, and one or more magnetometers. The sensor suite can additionally or alternatively include a wireless IMU (WIMU), one or more cameras, one or more microphones, or other sensors or data input devices capable of receiving and/or recording information relating to navigating a route to pick up, transport, and/or drop off a requester.

In particular embodiments, the vehicle subsystem 1008 may include a communication device capable of communicating with the client device 1006 and/or the transportation matching system 1002. For example, the vehicle subsystem 1008 can include an on-board computing device communicatively linked to the network 1004 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

1. A method comprising:
receiving, by a transportation matching system, a transportation request from a requestor computing device associated with a venue;
assigning, in response to receiving the transportation request, a queue position within a virtual queue to the requestor computing device based at least in part on location data associated with the requestor computing device and an estimated time of arrival for the requestor computing device at a pickup location associated with the venue;
monitoring, after assigning the queue position to the requestor computing device, the location data associated with the requestor computing device;
based on the location data of the requestor computing device, reassigning the requestor computing device to a different queue position within the virtual queue;
determining, based on a number of currently issued requestor identifiers, a number of currently available provider computing devices, and a number of pickup positions within the pickup location, a variable number of top virtual queue positions available to receive a requestor identifier;
determining that the reassigned queue position of the requestor computing device is within the variable number of top virtual queue positions;
providing, in response to determining that the reassigned queue position of the requestor computing device is within the variable number of top virtual queue positions, a requestor identifier for display on the requestor computing device;
receiving, from a provider computing device associated with the venue, the requestor identifier; and
in response to receiving the requestor identifier from the provider computing device, updating, within the transportation matching system, a status for the transportation request to indicate that the transportation request has been matched to the provider computing device.

2. The method as recited in claim 1, further comprising:
determining, based on the transportation request, that a current location of the requestor computing device is different from the pickup location; and
assigning the queue position to the requestor computing device based on determining that the current location of the requestor computing device is different from the pickup location.

3. (canceled)

4. The method as recited in claim 3, wherein determining the estimated time of arrival associated with the requestor computing device relative to the pickup location associated with the venue is based on one or more of a travel speed associated with the requestor computing device, a direction of travel associated with the requestor computing device, or a distance between the current location of the requestor computing device and the pickup location associated with the venue.

5. (canceled)

6. The method as recited in claim 1, further comprising:
analyzing an activity history associated with the venue to determine a historical average ETA; and
wherein assigning the queue position to the requestor computing device is further based on the historical average ETA.

7. (canceled)

8. (canceled)

9. The method as recited in claim 1, further comprising:
determining a wait time associated with a queue associated with an additional pickup location of the venue is less than a present wait time associated with the requestor computing device's queue position;
in response to determining the wait time, assigning the requestor computing device a queue position in the queue associated with the additional pickup location; and
generating a notification related to the additional pickup location.

10. The method as recited in claim 1, further comprising:
determining, after a threshold amount of time, that the requestor identifier has not been received from a provider computing device; and
expiring the requestor identifier provided to the requestor computing device.

11. The method as recited in claim 1, further comprising:
determining, based on an analysis of the monitored location data associated with the requestor computing device, that the requestor computing device is moving away from the pickup location associated with the venue; and
expiring the requestor identifier provided to the requestor computing device.

12. A system comprising:
at least one processor; and
at least one non-transitory computer-readable storage medium storing instructions thereon that, when executed by the at least one processor, cause the computing device to:
receive a transportation request from a requestor computing device associated with a venue;
assign, in response to receiving the transportation request, a queue position within a virtual queue to the requestor computing device based at least in part on location data associated with the requestor computing device and an estimated time of arrival for the requestor computing device at a pickup location associated with the venue;
monitor, after assigning the queue position to the requestor computing device, the location data associated with the requestor computing device;
based on the location data of the requestor computing device, reassign the requestor computing device to a different queue position within the virtual queue;
determine, based on a number of currently issued requestor identifiers, a number of currently available provider computing devices, and a number of pickup positions within the pickup location, a variable number of top virtual queue positions available to receive a requestor identifier;
determine that the reassigned queue position of the requestor computing device is within the variable number of top virtual queue positions;
provide, in response to determining that the reassigned queue position of the requestor computing device is within the variable number of top virtual queue positions, a requestor identifier for display on the requestor computing device;
receiving, from a provider computing device associated with the venue, the requestor identifier; and
in response to receiving the requestor identifier from the provider computing device, updating, within the transportation matching system, a status for the transportation request to indicate that the transportation request has been matched to the provider computing device.

13. (canceled)

14. The system as recited in claim 13, wherein determining the estimated time of arrival associated with the requestor computing device relative to the pickup location associated with the venue is based on one or more of a travel speed associated with the requestor computing device, a direction of travel associated with the requestor computing device, or a distance between the current location of the requestor computing device and the pickup location associated with the venue.

15. (canceled)

16. The system as recited in claim 15, further storing instructions thereon that, when executed by the at least one processor, cause the computing device to:
analyze an activity history associated with the venue to determine a historical average ETA; and
wherein assigning the queue position to the requestor computing device is further based on the historical average ETA.

17. (canceled)

18. (canceled)

19. The system as recited in claim 18, further storing instructions thereon that, when executed by the at least one processor, cause the computing device to:
determine a wait time associated with a queue associated with an additional pickup location of the venue is less than a present wait time associated with the requestor computing device's queue position;
in response to determining the wait time, assign the requestor computing device a queue position in the queue associated with the additional pickup location; and
generate a notification related to the additional pickup location.

20. A non-transitory computer-readable medium storing instructions thereon that, when executed by at least one processor, cause a system to:
receive a transportation request from a requestor computing device associated with a venue;
assign, in response to receiving the transportation request, a queue position within a virtual queue to the requestor computing device based at least in part on location data associated with the requestor computing device and an estimated time of arrival for the requestor computing device at a pickup location associated with the venue;
monitor, after assigning the queue position to the requestor computing device, the location data associated with the requestor computing device;
based on the location data of the requestor computing device, reassign the requestor computing device to a different queue position within the virtual queue;
determine, based on a number of currently issued requestor identifiers, a number of currently available provider computing devices, and a number of pickup positions within the pickup location, a variable number of top virtual queue positions available to receive a requestor identifier;
determine that the reassigned queue position of the requestor computing device is within the variable number of top virtual queue positions;
provide, in response to determining that the reassigned queue position of the requestor computing device is within the variable number of top virtual queue positions, a requestor identifier for display on the requestor computing device;
receive, from a provider computing device associated with the venue, a requestor identifier; and
in response to receiving the requestor identifier from the provider computing device, updating, within the transportation matching system, a status for the transportation request to indicate that the transportation request has been matched to the provider computing device.

21. The method as recited in claim 1, wherein monitoring, after assigning the queue position to the requestor computing device, the location data associated with the requestor computing device comprises determining at least one of a change of location of the requestor computing device, a change of direction of the requestor computing device, or a change of speed of the requestor computing device.

22. The method as recited in claim 21, wherein reassigning the requestor computing device to a different queue position within the virtual queue comprises:
monitoring location data associated with a different requestor computing device assigned a higher queue position within the virtual queue than the queue position assigned to the requestor computing device;
determining, based on the monitored location data associated with the requestor computing device and the monitored location data associated with the different requestor computing device, that the requestor computing device will arrive at the at least one pickup location associated with the venue prior to the different requestor computing device;
reassigning, to the requestor computing device, the queue position previously assigned to the different requestor computing device.

23. The non-transitory computer-readable medium as recited in claim 20, further storing instructions thereon that, when executed by the at least one processor, cause a system to:
determine, based on the transportation request, that a current location of the requestor computing device is different from the pickup location; and
assign the queue position to the requestor computing device based on determining that the current location of the requestor computing device is different from the pickup location.

24. The non-transitory computer-readable medium as recited in claim 23, wherein determining the estimated time of arrival associated with the requestor computing device relative to the pickup location associated with the venue is based on one or more of a travel speed associated with the requestor computing device, a direction of travel associated with the requestor computing device, or a distance between the current location of the requestor computing device and the pickup location associated with the venue.

25. The non-transitory computer-readable medium as recited in claim 24, further storing instructions thereon that, when executed by the at least one processor, cause a system to:
analyze an activity history associated with the venue to determine a historical average ETA; and
wherein assigning the queue position to the requestor computing device is further based on the historical average ETA.

26. The non-transitory computer-readable medium as recited in claim 25, further storing instructions thereon that, when executed by the at least one processor, cause a system to:
determine a wait time associated with a queue associated with an additional pickup location of the venue is less than a present wait time associated with the requestor computing device's queue position;
in response to determining the wait time, assign the requestor computing device a queue position in the queue associated with the additional pickup location; and
generate a notification related to the additional pickup location.

27. The non-transitory computer-readable medium as recited in claim 26, further storing instructions thereon that, when executed by the at least one processor, cause a system to:
determine, after a threshold amount of time, that the requestor identifier has not been received from a provider computing device; and
expire the requestor identifier provided to the requestor computing device.

28. The non-transitory computer-readable medium as recited in claim 27, further storing instructions thereon that, when executed by the at least one processor, cause a system to:
determine, based on an analysis of the monitored location data associated with the requestor computing device, that the requestor computing device is moving away from the pickup location associated with the venue; and
expire the requestor identifier provided to the requestor computing device.
